(19) United States
(12) Patent Application Publication
(10) Pub. No.: US 2026/0270293 A1
(43) Pub. Date: Sep. 10, 2026

(54) SCALABLE SYSTEM AND METHOD FOR REDUCING IMPACT OF MALICIOUS COMPONENTS IN A NETWORK OF INTERACTING ENTITIES

(71) Applicant: THE UNIVERSITY OF WESTERN ONTARIO, London, Ontario (CA)

(72) Inventors: Konstantinos KONTOGIANNIS, London, Ontario (CA); Konstantinos TSIOUNIS, London, Ontario (CA)

(21) Appl. No.: 19/491,349

(22) PCT Filed: Jun. 9, 2023
(86) PCT No.: PCT/CA2023/000012

§ 371 Date: Dec. 8, 2025

(51) Int. Cl. H04L 9/40

(52) U.S. Cl. CPC H04L 63/1441

(57) ABSTRACT

A computer-implemented method including: communicatively connecting a requester to a plurality of recommenders and a plurality of providers, at least a portion of the plurality of recommenders being clients of at least a portion of the plurality of providers; receiving from the requester a query including information relating to a type of service; identifying a provider based on the query; sending to the requester, a recommendation of the provider based on a recommender trust value and a recommender distrust value evaluating performance of the provider, both the recommender trust value and the recommender distrust value being independent such that the sum of the recommender trust value and the recommender distrust value is variable; receiving from the requester, an observed trust value and an observed distrust value evaluation of performance of the provider in a requester-provider interaction, both the observed trust value and the observed distrust value being independent such that the sum of the observed trust value and the observed distrust value is variable; revising a recommender reputation value by comparing the observed trust value and the observed distrust value to the recommender trust value and the recommender distrust value; revising a client trust value and client distrust value for the provider based on the observed trust value and observed distrust value. Systems and non-transitory computer readable media for executing the method are also described.

### BACKGROUND OF THE INVENTION

### Field of the Invention

The present invention relates to quality of service, and more particularly to maintaining quality of service in a network of interacting entities.

### Description of the Related Art

Interacting entities can act as clients seeking access to resources and services, and as providers offering access to such resources and services. Clients and providers are considered as virtual entities that coordinate with each other, and may include physical users, avatars, micro-services, software agents, smart contracts or any other distributed inter-networked resource, without making any assumptions as to what a client entity or a provider entity is as long as it participates in an interaction or executes a transaction over a computer network.

Current systems for monitoring quality of service suffer from centralized trust-assigning authorities and/or using single variable inputs for evaluating quality of service. Such systems have reduced flexibility to adapt to malicious agents/actors.

Accordingly, there is a continuing need for alternative methods and systems for reducing impact of malicious agents/actors in a network of interacting entities.

### SUMMARY OF THE INVENTION

In an aspect there is provided, a computer-implemented method for reducing impact of malicious components in a network of interacting entities, the method comprising:
providing a computer network configured to communicatively connect a requester to a plurality of recommenders and a plurality of providers, at least a portion of the plurality of recommenders being clients of at least a portion of the plurality of providers, a requester-recommender interaction characterized by a reputation value, a requester-provider interaction characterized by a client trust value and client distrust value that are both independent such that a sum of each corresponding client trust value and client distrust value is variable; a recommender-provider interaction characterized by a recommender trust value and recommender distrust value that are both independent such that a sum of each corresponding recommender trust value and recommender distrust value is variable;
providing an interface connected to the computer network, the interface configured to receive from the requester a query including information relating to a type of service;
identifying a provider based on the type of service;
sending to the requester, a recommendation of the provider based on a recommender trust value and a recommender distrust value evaluating performance of the provider, both the recommender trust value and the recommender distrust value being independent such that the sum of the recommender trust value and the recommender distrust value is variable;
receiving from the requester, an observed trust value and an observed distrust value evaluation of performance of the provider in a requester-provider interaction, both the observed trust value and the observed distrust value being independent such that the sum of the observed trust value and the observed distrust value is variable;
revising a recommender reputation value by comparing the observed trust value and the observed distrust value to the recommender trust value and the recommender distrust value;
revising a client trust value and client distrust value for the provider based on the observed trust value and observed distrust value.

In another aspect there is provided, a computer-implemented method comprising:
communicatively connecting a requester to a plurality of recommenders and a plurality of providers, at least a portion of the plurality of recommenders being clients of at least a portion of the plurality of providers;
receiving from the requester a query including information relating to a type of service;
identifying a provider based on the query;
sending to the requester, a recommendation of the provider based on a recommender trust value and a recommender distrust value evaluating performance of the provider, both the recommender trust value and the recommender distrust value being independent such that the sum of the recommender trust value and the recommender distrust value is variable;
receiving from the requester, an observed trust value and an observed distrust value evaluation of performance of the provider in a requester-provider interaction, both the observed trust value and the observed distrust value being independent such that the sum of the observed trust value and the observed distrust value is variable;
revising a recommender reputation value by comparing the observed trust value and the observed distrust value to the recommender trust value and the recommender distrust value;
revising a client trust value and client distrust value for the provider based on the observed trust value and observed distrust value.

In further aspects, systems and non-transitory computer readable media for executing the method are also provided.

### BRIEF DESCRIPTION OF THE DRAWINGS

FIG. 1 shows a flow diagram of an example of a method for reducing impact of malicious components in a network of interacting entities.

FIG. 2 shows a flow diagram of an example of a method to further define the method shown in FIG. 1.

FIG. 3 shows a flow diagram of an example of another method to further define the method shown in FIG. 1.

FIG. 4 shows a flow diagram of an example of yet another method to further define the method shown in FIG. 1.

FIG. 5 shows a system map of an example of interactions between client and provider components in a network of interacting entities.

FIG. 6 shows a flow diagram of an example of a variant method for reducing impact of malicious components in a network of interacting entities.

FIG. 7 shows a system graph of an example an interacting network of recommenders and services represented by labelled nodes and edges to illustrate the method shown in FIG. 6 in a running example.

FIG. 8 shows plots of experimental data demonstrating system stability in presence of malicious components.

FIG. 9 shows plots of experimental data demonstrating dynamic adjustment of service reputation and recognition of degrading service within the network.

FIG. 10 shows plots of experimental data demonstrating benefit of multiple recommendation sources and adaptation of recommendation numbers from each source.

FIG. 11 shows plots of experimental data demonstrating a performance advantage of independent trust and distrust values compared to dependent trust and distrust values.

FIG. 12 shows plots of experimental data demonstrating a performance advantage of independent trust and distrust values compared to trust values alone.

FIG. 13 shows an example of an electronic user interface interactive form to initiate a request, including a requester's assessment criteria.

FIG. 14 shows an example of an electronic user interface form for displaying a ranked list of selected providers.

FIG. 15 shows an example of an electronic user interface interactive form for a client to assess a service provider.

FIG. 16 shows an example of a goal model approach for service evaluation.

FIG. 17 shows an example of a system architecture and communicative connection of computing components to provide a computing framework for the network of interacting entities.

### DETAILED DESCRIPTION OF PREFERRED EMBODIMENTS

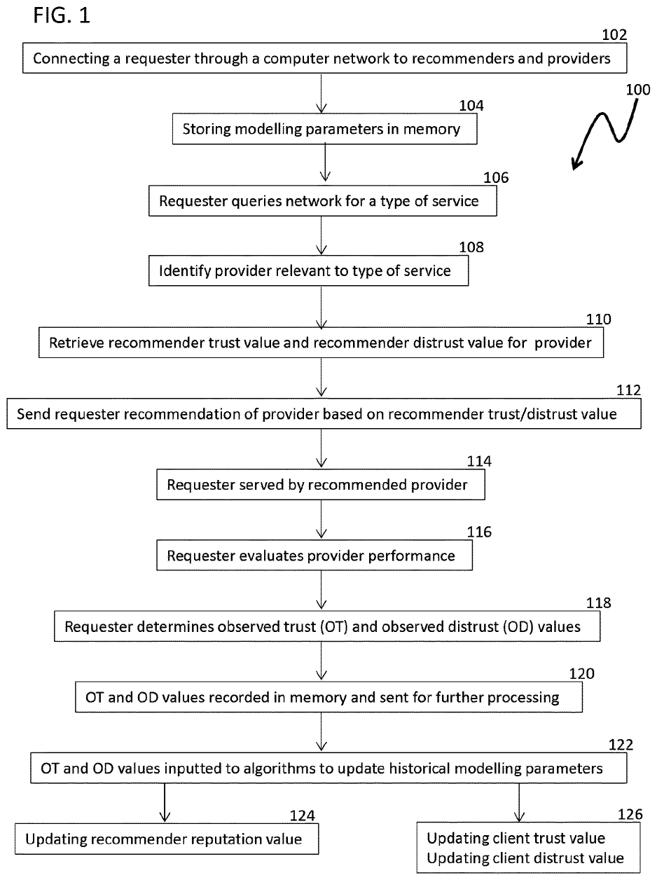

Referring to FIG. 1, an example of a computer-implemented method for reducing impact of malicious components in a network of interacting entities is described. The method 100 provides a computer network configured to communicatively connect a requester to a plurality of recommenders and a plurality of providers 102, at least a portion of the plurality of recommenders being clients of at least a portion of the plurality of providers.

The method 100 stores modelling parameters in memory including a reputation value, a client trust value and a client distrust value, and a recommender trust value and recommender distrust value 104. The reputation value is based at least in part on an evaluation of a requester-recommender interaction. The client trust value and the client distrust value are both based at least in part on an evaluation of a requester-provider interaction. The client trust value and the client distrust value are independent variables such that a sum of each corresponding client trust value and client distrust value is variable. The recommender trust value and the recommender distrust value are both based at least in part on an evaluation of a recommender-provider interaction. The recommender trust value and the recommender distrust value are independent variables such that a sum of each corresponding recommender trust value and recommender distrust value is variable.

The method 100 provides an interface connected to the computer network, the interface configured to receive from the requester a query 106 including information relating to a type of service. In response to the query a provider is identified 108 based at least in part on the type of service; and the requester is sent a recommendation 112 of the provider based on a recommender trust value and a recommender distrust value evaluating performance of the provider 110, both the recommender trust value and the recommender distrust value being independent such that the sum of the recommender trust value and the recommender distrust value is variable.

Once the requester is served by the recommended provider 114, the requester evaluates the requester-provider interaction 116, and more particularly the requester determines an observed trust value and an observed distrust value to evaluate the performance of the provider 118 in the requester-provider interaction, both the observed trust value and the observed distrust value being independent such that the sum of the observed trust value and the observed distrust value is variable. The observed trust value and observed distrust value are sent to memory and to a processor component 120 and used as inputs to algorithmically update historical parameters 122 associated with the requester, the recommender, the provider, or any combination thereof. For example, a recommender reputation value is revised 124 by comparing the observed trust value and the observed distrust value to the recommender trust value and the recommender distrust value. As another example, a client trust value and client distrust value for the provider is revised 126 based on the observed trust value and observed distrust value.

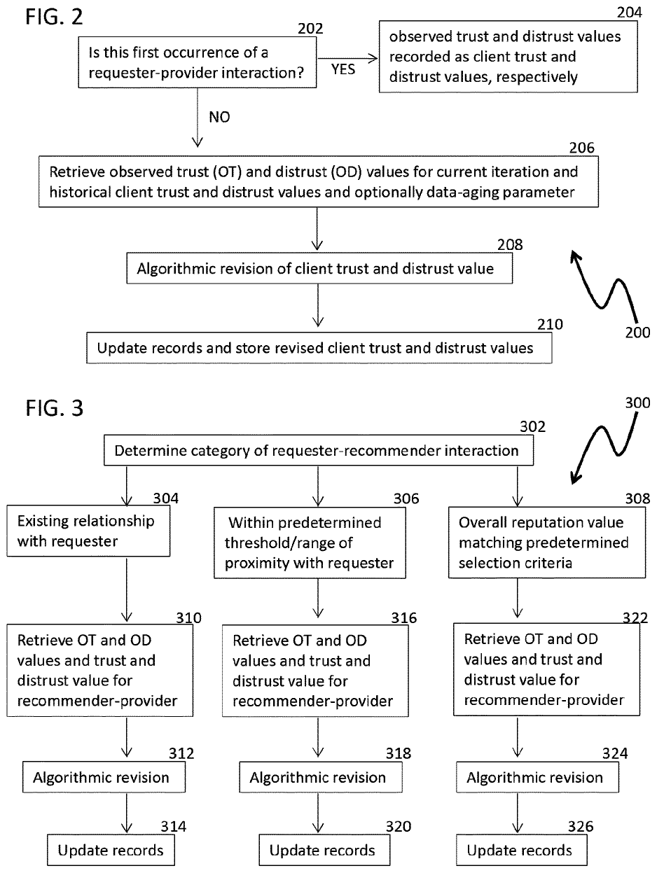

Referring to FIG. 2, method 200 implemented in conjunction with method 100, is an illustrative further delineation of step 126 in updating the client trust value and client distrust value.

After an iteration of a requester-provider interaction and after receiving corresponding observed trust and observed distrust values from the requester a client trust value and client distrusts value is calculated that is pairwise specific, in that the client trust and distrust value are specific to each requester-provider relationship and, if occurring over multiple interactions represent a historical evaluation of the specific pair of the requester-provider relationship. For example, upon multiple iterations of the requester-provider interactions and updating the client trust value and client distrust value after each interaction, the client trust and client distrust values for the requester-provider relationship becomes a historically accumulated trust and distrust value pairwise specific to the requester and the provider. In each iteration of interaction, a determination is made whether a requester-provider interaction of a current iteration has been preceded by a interaction by the same requester-provider pair 202, and if no record of a previous interaction is found then a determination is made that the current iteration is a first occurrence of an interaction between the requester-provider pair and the observed trust and distrusts values are retrieved and recorded as the client trust and distrusts values, respectively 204. If records of a previous interaction is found, for example a record of previous client trust and distrust values for the specific requester-provider pair of the current iteration, then the observed trust and distrust values for the current iteration and the previous client trust and distrust values and optionally data-aging parameter are retrieved 206 and inputted to an algorithm component to determine a revised client trust and distrust values 208. The revised client trust and distrust values are stored in memory as current client trust and distrust values 210.

In an example of two or more previous interactions between the specific requester-provider pair, the previous trust value is accumulated from a plurality of previous trust values pairwise specific to the requester and the provider; the client trust value is revised based on the observed trust value, the previous trust value, and a trust-data aging parameter. Similarly, in this example of two or more previous interactions, the previous distrust value is accumulated from a plurality of previous distrust values pairwise specific to the requester and the provider; the client distrust value is revised based on the observed distrust value, the previous distrust value, and a distrust-data aging parameter. The trust-data aging parameter may be the same or different than the distrust-data aging parameter as may be suited to a particular implementation. Furthermore, various algorithms for data-aging adjustment are contemplated, including for example calculating a trust-data aging offset based on the discrepancy between the observed trust value and the previous trust value weighted by the trust-data aging parameter; calculating a distrust-data aging offset based on the discrepancy between the observed trust value and the previous trust value weighted by the distrust-data aging parameter; and optionally calculating the revised client trust and client distrust values based on applying the trust-data and distrust-data aging offsets to the previous client trust and client distrust values, respectively.

Referring to FIG. 3, method 300 implemented in conjunction with method 100, is an illustrative further delineation of step 124 in updating a recommender reputation value.

An iteration of a requester-provider interaction includes a requester-recommender interaction in the form of a recommendation (for example, step 112 in FIG. 1), and after receiving corresponding observed trust and observed distrust values from the requester a recommender reputation value is calculated that is pairwise specific, in that the recommender reputation value is specific to each requester-recommender relationship and, if occurring over multiple interactions represent a historical evaluation of the specific pair of the requester-recommender relationship. For example, upon multiple iterations of the requester-recommender interactions and updating the recommender reputation value after each interaction, the recommender reputation value for the requester-recommender relationship becomes a historically accumulated trust and distrust value pairwise specific to the requester and the recommender.

In each iteration of interaction, a determination is made as to a category of requester-recommender interaction 302, for example determining whether a requester-recommender interaction of a current iteration is from:
a first category of a first recommender that has an existing first reputation value pairwise specific to the requester and the recommender 304;
a second category of a second recommender lacking a history of direct interaction with the requester but within a predetermined selection threshold or range of proximity with the requester, for example the second recommender having an existing second reputation value pairwise specific to the first recommender 306; and
a third category of a third recommender having a third reputation value that is an overall or global reputation value that matches a predetermined selection criteria 308.

Each category may have different considerations for algorithmic revision and updating of reputation values. For example, for the first category the observed trust and distrust values for the current iteration and the corresponding first recommender trust and distrust values for the specific recommender-provider pair and the first reputation value are retrieved 310 and inputted to an algorithm component to determine a revised recommender reputation value 312. The revised recommender reputation value is stored in memory as a current recommender reputation value associated with and specific to the requester and first recommender pair 314. As another example, for the second category the observed trust and distrust values for the current iteration and the corresponding second recommender trust and distrust values for the specific recommender-provider pair and the first reputation value and the second reputation value are retrieved 316 and inputted to an algorithm component to determine a revised recommender reputation value 318. The revised recommender reputation value is stored in memory as a current recommender reputation value associated with and specific to the requester and second recommender pair 320. As another example, for the third category the observed trust and distrust values for the current iteration and the corresponding third recommender trust and distrust values for the specific recommender-provider pair and the third reputation value are retrieved 310 and inputted to an algorithm component to determine a revised recommender reputation value 312. The revised recommender reputation value is stored in memory as a current recommender reputation value that is an overall or global reputation value that is not specific to the requester and third recommender pair 314.

Considering the first category and first recommender for further illustration, the recommender reputation value is a historically accumulated reputation value pairwise specific to the requester and the recommender calculated based on the observed trust value and the recommender trust value discrepancy, the observed distrust value and the recommender distrust value discrepancy, and a previous reputation value recorded prior to sending the recommendation.

In an example of two or more previous interactions between the specific requester-recommender pair, the previous reputation value is accumulated from a plurality of previous calculated recommender reputation values pairwise specific to the requester and the recommender; and the recommender reputation value is revised based on the observed trust value and the recommender trust value discrepancy, the observed distrust value and the recommender distrust value discrepancy, the previous reputation value and optionally a reputation-data aging parameter. Furthermore, various algorithms for data-aging adjustment are contemplated, including for example calculating a reputation-data aging offset based on the observed trust value and the recommender trust value discrepancy, the observed distrust value and the recommender distrust value discrepancy, and weighting by the reputation-data aging parameter; and optionally calculating the revised recommender reputation value based on applying the reputation-data aging offset to the previous reputation value.

As seen in the third category with the third recommender, the observed trust and observed distrust values are used to determine a revised overall or global recommender reputation value for the third recommender that is not specific to the requester and third recommender pairing. Each of the first recommender, second recommender and third recommender can have a revision to their respective overall recommender reputation value as a result of the current iteration. For the third recommender, the overall recommender reputation value is calculated without first calculating a pairwise specific recommender reputation value. In contrast, for the first recommender and second recommender a revision of their respective pairwise specific recommender reputation value is executed followed by revision of their respective overall recommender reputation values. In an example, an overall recommender reputation value for the recommender (each of the first or second or third recommender) based on a plurality of recommender reputation values specific to the recommender, each of the plurality of recommender reputation values pairwise specific to the recommender and a unique single client from a plurality of clients. Thus, the overall recommender reputation value is an accumulation of all the pairwise specific recommender reputation value that have been determined for the recommenders interaction within the network. In another example, the overall recommender reputation value is revised based on summation of the plurality of recommender reputation values with each of the plurality of recommender reputation values weighed according to an overall reputation value specific to each corresponding unique single client.

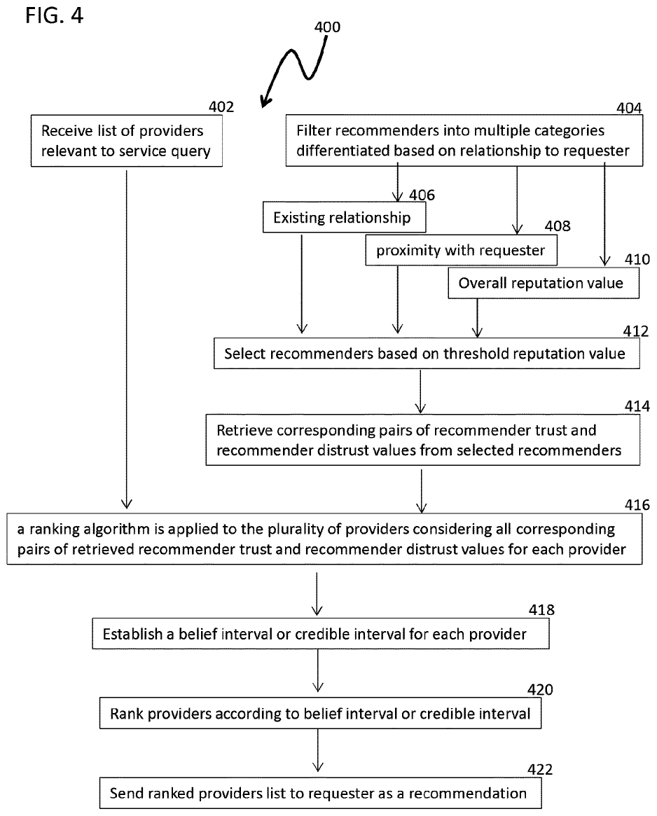

Referring to FIG. 4, method 400 implemented in conjunction with method 100, is an illustrative further delineation of steps 110 and 112 in selecting a plurality of recommenders for plurality of providers and formulating a list of the plurality of providers ranked based on recommender trust and distrust values provided by the plurality of recommenders.

An iteration of a requester-provider interaction includes a requester-recommender interaction in the form of a recommendation (for example, step 112 in FIG. 1). Typically, the recommendation received by the requester identifies a plurality of providers in a ranked list.

To generate the ranked list a plurality of providers relevant to the service query of the requester are identified 402. Recommenders, specifically a plurality of recommenders, are also filtered by categories 404 and selected 412, and typically each recommender will have had a previous interaction with at least one of the plurality of providers such that each recommender is associated with at least one corresponding pair of recommender trust and recommender distrust values for at least one of the plurality of providers. The recommenders may be categorized by predefined criteria. Each of the plurality of recommenders is independently selected from any number of categories and multiple recommenders from each category may be selected 404. Each category is not only distinguished from other categories based on predefined criteria for filtering historical interaction with the requester, but is also distinguishable based on algorithms employed to calculate recommender reputation values. Consistent with the above description of steps 304, 306, and 308, an example of recommender categories include:
a first category of a first recommender that has an existing first reputation value pairwise specific to the requester and the recommender 406;
a second category of a second recommender lacking a history of direct interaction with the requester but within a predetermined selection threshold or range of proximity with the requester, for example the second recommender having an existing second reputation value pairwise specific to the first recommender 408; and
a third category of a third recommender having a third reputation value that is an overall or global reputation value that matches a predetermined selection criteria 410.

Examples of selection criteria include:
the first recommender selected based on the first reputation value being greater than a first predetermined threshold;
the second recommender is selected based on the multiplication product of the second reputation value and the first reputation value being greater than a second predetermined threshold; and
the third recommender selected based on the overall reputation value being greater than a third predetermined threshold.

A recommender may be chosen based on overall (also referred to as global) reputation value, even if they have a direct connection to the requester (i.e., an existing relationship with an existing first reputation value such as an R value). A benefit of considering overall/global reputation values regardless of presence of interaction history is that it helps avoid reaching a state of equilibrium where no further changes occur. If, for example, a requester/client has a low first reputation value (such as R value) for a recommender, the requester/client may not consult them directly, but may choose the recommender based on overall/global reputation value and a compatible outcome of the requester-provider interaction with the recommender's trust and distrust values pairwise specific to the provider would cause the requester/client to update and improve their opinion for the recommender.

To produce the ranked list corresponding pairs of recommender trust and distrusts values are retrieved for the selected recommenders 414, a ranking algorithm is applied to the plurality of providers considering all corresponding pairs of retrieved recommender trust and recommender distrust values for each of the plurality of providers 416, and since the ranking algorithm must consider corresponding pairs of recommender trust values and recommender distrust values, the ranking algorithm must be capable of combining positive and negative evidences. In one example, the plurality of providers are ranked by executing a combining of positive and negative evidences algorithm and establishing a belief interval or credible interval for each of the plurality of providers 418, ranking providers according the belief interval or credible interval 420, and incorporating the ranked provider list into a recommendation and sending the recommendation to the requester 422. In another example, the plurality of providers are ranked by executing a Dempster-Shafer algorithm based on a plurality of client trust values and a plurality of client distrust values specific to each provider and establishing a belief interval or credible interval for each of the plurality of providers.

For convenience of executing any of methods 100, 200, 300 and 400 or validating any of methods 100, 200, 300 and 400 the network of interacting entities may be modelled as a graph, the graph comprising nodes connected by edges, each node independently representing the requester, one of the plurality of the recommenders, or one of the plurality of providers, each edge bound by a node pairing and each edge defined by a value of the requester-recommender interaction, the requester-provider interaction, or the recommender-provider interaction in accordance with each specific node pairing. Typically, a majority of the plurality of recommenders and a majority of the plurality of providers are autonomous entities.

The interaction between the requester and provider may be a transaction, including for example a requester-provider interaction in which the requester sends payment to the provider in exchange for a service or product from the provider. In other examples pertaining to a transactional interaction of requester and provider, the provider may offer an incentive included in the recommendation sent to the requester or the provider may offer a compensation to adjust the observed trust value or the observed distrust value sent by the requester to evaluate the performance of the provider in the requester-provider interaction.

Methods 100, 200, 300 and 400 may be combined as desired to achieve a level of performance suited to a particular implementation. In an example, steps from methods 100, 200, 300, and 400 are extracted and expanded to provide an illustrative sequence of steps that can achieve reduction of impact of malicious components in a network of interacting entities.

Step 1: A client expresses interest in using a type of service. A service is considered any form of functionality or asset delivered by a service provider, and is of use to a client in a given context. Examples of services include a credit card payment clearance service, a cloud hosting service, a retail service, a service providing non-fungible tokens (NFTs) in a e-trading platform, or a service offering gaming credits or other virtual assets to an avatar in on-line game or in a metaverse environment. Example contexts can be an e-commerce session, a gaming session, an interaction between two avatars engaging in communication in a metaverse environment.

Step 2: Recommenders, belonging to a variety of different groups and having a reputation value that exceeds a certain threshold, are selected for consultation, and their positive and negative opinions about candidate services are collected. A combination of recommenders acquired through global consensus and recommenders for which the client has a personal opinion provides an advantageous result when it comes to the performance of the proposed method as compared to consideration of either global recommender reputation alone or local recommender reputation alone. A positive opinion (T value) denotes the level to which the recommender recommends the service provider. A negative opinion (D value) denotes the level to which the recommender has reservations about the service provider. For example, a recommender may provide a positive opinion in the form of a score equal to 0.8 because it knows from its past interactions with the service provider that the provider sells high quality products, and a negative opinion with a score value 0.4 because the service provider is not very punctual on answering questions from potential clients. The positive and negative opinions from a recommender are independent values (for example they do not need to sum up to 1).

Step 3 (Optional): For each recommended candidate service, if the client has its own positive (T value) and negative opinion (D value), these opinions are added to the list of positive and negative opinions obtained from the recommenders.

Step 4. The positive and negative opinions for the services a recommender recommends, are transformed into a format suitable for an algorithm combining positive and negative opinions.

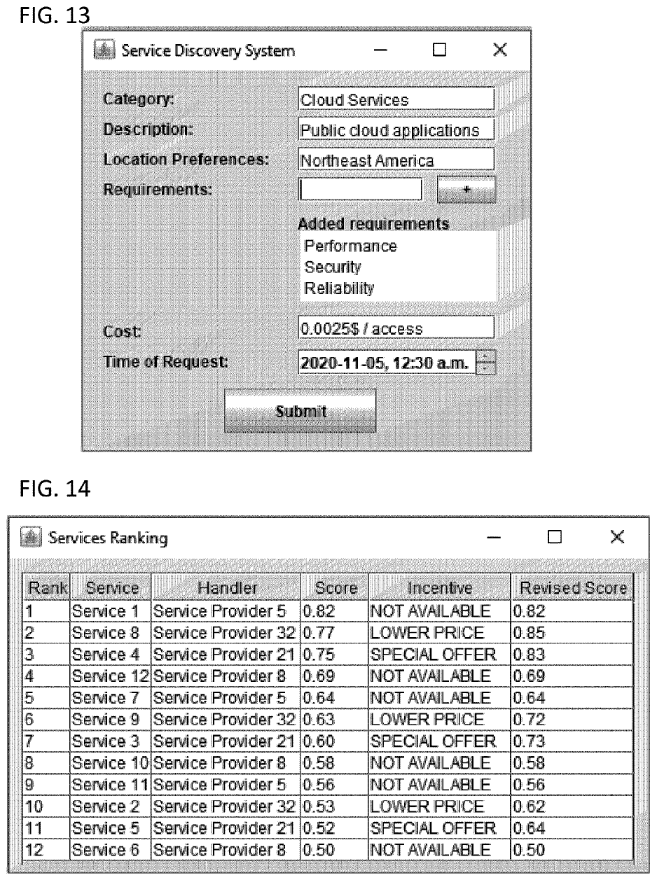

Step 5: For each recommended candidate service, all positive and negative opinions for this service (i.e. the positive and negative opinions of the recommenders along with the positive and negative opinions of the client itself) are combined into single score value, or into a single score value supplemented with additional information (e.g. other values) to represent the level of uncertainty this combined single score value has, given the opinions of the recommenders for each given service. In this respect, for each recommended candidate service, the client has in its disposal tuples (i.e. tuples containing the score value along with any other supplemental values indicating the level of uncertainty in this score value). For example, in the literature of evidential support [28], [32], the belief towards an hypothesis is supplemented with a plausibility value, thus forming an interval the width of which indicates the level of uncertainty one has on the belief towards the hypothesis, given all the collected evidences. The list of tuples is ranked and presented to the client. The list can be denoted in various electronic forms (XML, text, JSON etc.). In one exemplification, the client is presented with a table of ranked services, such as the one in FIG. 14.

Step 6: The client chooses their preferred service and proceeds with using said service. Optionally, the client may be offered incentives that will prompt them to choose a service other than the one with the highest ranking. In this case, the client may opt to use a service that is further down the ranking, or even a service that is not in the list whatsoever but may be known to the client through advertisement or other means. An “incentive” can be a tangible asset a service provider may offer to the client for the purpose of incentivizing them to choose its service over others. Example incentives could include extending the available time of use, a rebate, reduced price for using the service, or promise of other future benefits. This technique also allows new services to enter the system and gradually improve their score value.

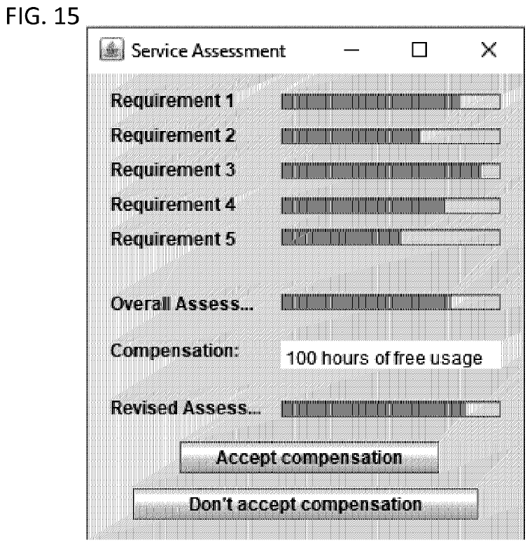

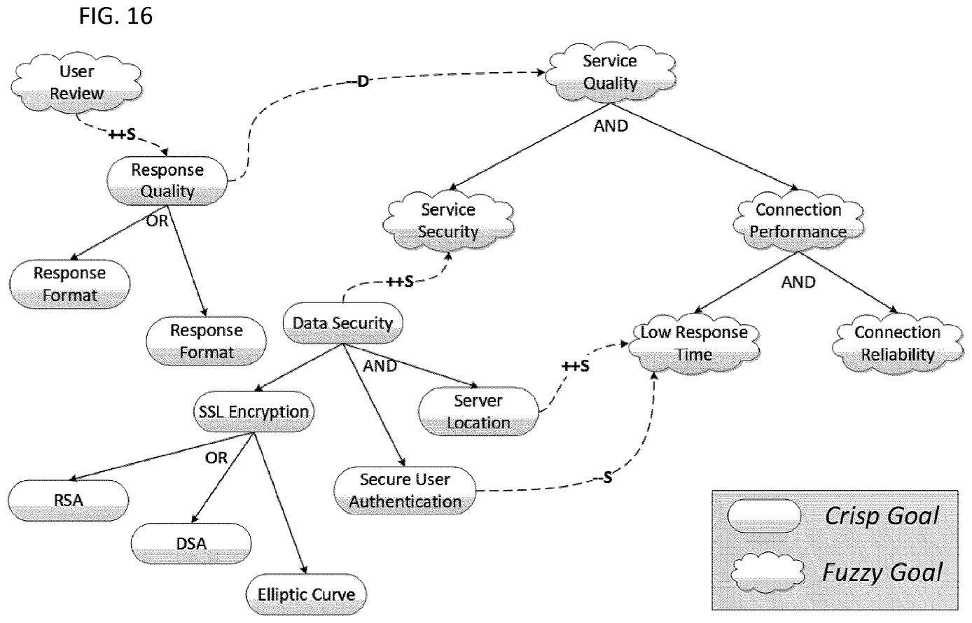

Step 7: Once the client has used the selected service, the quality of service experienced is assessed either automatically, through a reasoning process associated with the client using various reasoning frameworks such as, but not limited to, fuzzy reasoners, rules, machine learning, goal models as depicted in FIG. 16, or through explicit user feedback as depicted in FIG. 15. The result of assessing the quality of the service, as it has been experienced by the client in its current interaction with the service, is modelled as a pair of values denoting a measure of belief (OT value) and a measure of disbelief (OD value) towards the quality of the said service. The measure of belief, measures the increase on the belief the client has that the service is of high quality, given as evidence the quality it has experienced in its current interaction with the said service. The measure of disbelief, measures the increase on the disbelief the client has that the service is of high quality, given as evidence the quality it has experienced in its current interaction with the service. The concepts of measure of belief (MB) and measure of disbelief (MD) have been proposed and investigated by the AI research community in the context of evidential reasoning [28], [32].

An example of measure of belief in an interaction can be “The service's time performance I experienced in my current interaction increases, with a value 0.9, my belief that this is a service of high quality” (OT value). An example of measure of disbelief can be “The service's long time to acknowledge my initial request increases my disbelief, with a value of 0.3, that this is a service of high quality” (OD value).

Optionally, the client may choose to adjust the measure of belief and measure of disbelief due to a compensation. The service provider may offer a “compensation” as a means of mitigating any occasional reductions in QoS the client may have experienced in their current interaction. Examples of compensation, for example shown in FIG. 15, which may be provided by a service, in order for the client to adjust its measure of belief (OT value) and measure of disbelief (OD value) values, could include the offer of extension of service use time, credits, vouchers, or monetary benefits.

Step 8: For every recommender that provided a recommendation for the selected by the client service, their R value is updated. If the recommender provided a recommendation compatible with the quality of service the client experienced, the reputation of the recommender is increased, otherwise it is decreased (see an exemplification in the Calculate R-value Algorithm).

Step 9 (Optional): For every recommender that provided a recommendation related to the service used, their overall reputation (AR value), is updated, as a result of the update of their R value (see previous step). The AR value for a recommender represents the cumulative reputation the recommender has, as a function of all the opinions (R values) the nodes in the network have for this recommender (see an exemplification in the calculate AR-value Algorithm).

Step 10: The client's overall positive opinion (T value) and negative opinion (D value) about the service selected and used by the client is updated as a function of a) the previous T and D values the client had (if any) and b) the OT and OD values the client computed after its latest interaction with the selected service (see an exemplification in the Calculate T-D-values Algorithm).

The methods and systems for reducing impact of malicious agents/actors in a network of interacting entities have been validated by experimental testing. Experimental testing results demonstrate the ability of the presently disclosed methods and systems to monitor quality of service and reduce impact of malicious agents/actors in a network of interacting entities. The following experimental examples are for illustration purposes only and are not intended to be a limiting description.

Experimental Exemplification: Experimental Example 1. This example shows that the presently disclosed methods and systems exhibit high resilience and network stability for significant percentages of malicious agents aiming at degrading quality of service in a network.

The current exemplification provides for assigning independent trust and distrust values to a service provider given the behavior different service clients have experienced when using the service offered by this service provider. The basic model is a graph where nodes are service clients and service providers, and the edges denote levels of trust/distrust (or reputation based on trust/distrust values) from one node to the other. Service clients can serve as recommenders for a service provider after having used this provider and having assessed how well the service provider meets the requirements or expectations of the service client. This assessment can be based on evaluating how well a service provider has satisfied the client's intents and QoS expectations from a service provider. In this exemplification a client's intents and expectations are modelled as Goal Models. Other modeling mechanisms such as UML (Unified Modeling Language), i* (i star) models, or rules can also be used. A service is selected by a client, by considering both its own past experience of using the service provider, and the recommendations provided by other clients who have used the provider. A dynamic mechanism allows for adjusting the reputation a service client has as recommender. The currently exemplified framework can be deployed in a fully distributed manner, where each node/edge maintains its respective trust/distrust/reputation values.

Validation tests indicate that the exemplified system and method exhibits significant resilience even when a large number of malicious recommenders infiltrates the network and also allows for degrading service providers to be identified and isolated quickly. In this context, malicious components are shown to be isolated after a short number of interactions, while non-malicious components form their own communities and continue to receive accurate assessments of available service providers.

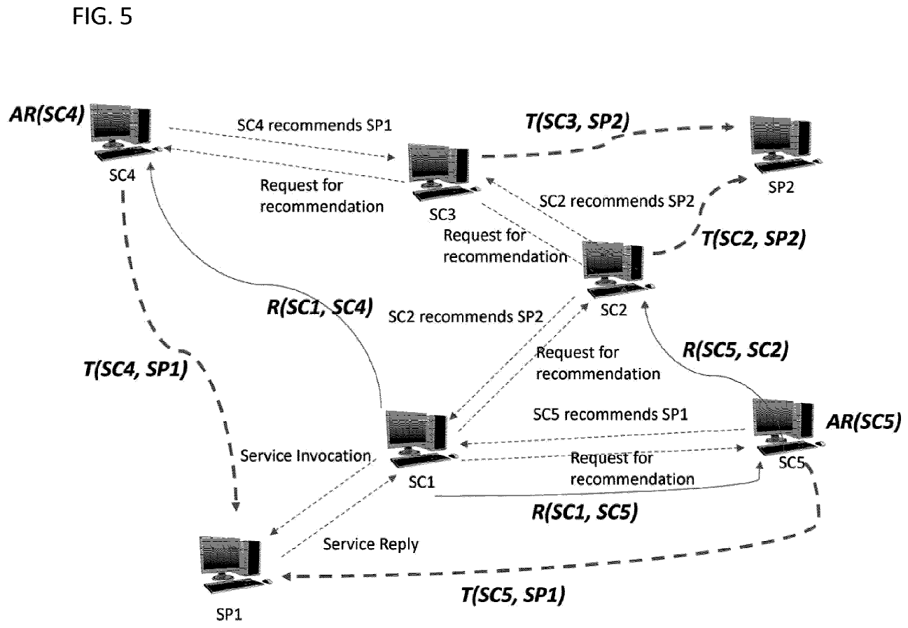

Experimental Example 1: Modelling Entities. This example is based on a) a service client (say SC1) issuing a request to other service clients (say SC2, and SC3) in order to obtain recommendations for services offering a given type of service b) once the service client SC1 uses a service (say SP1) as a result of such recommendations, i) assigning a metric value indicating the measure of belief (trust) of how the service provider was perceived to have met the client's expectations (i.e. how well the service SP1 met the SC1's expectations); ii) assigning a metric value indicating the measure of belief of how the service provider was perceived to have failed the client's expectations (i.e. SC1's disbelief on SP1); iii) assigning a metric value indicating how good the recommenders SC2 and SC3 were given that SC1 now has a firsthand experience using SP1. We assume that service clients SC2 and SC3 have already used the service SP1 and therefore are able to provide their recommendation. The aforementioned interactions between SCs (i.e. requests for recommendations, responses to requests for recommendations), and between SCs and SPs (i.e., service invocations, service responses) create a graph where nodes are SCs and SPs and edges are these types of interactions (see FIG. 5).

In this respect, a level of belief/disbelief a service client has that a service provider will indeed deliver the quality of service (QoS) the client expects, is assigned to each service, and a level of reputation is assigned to each client for its ability to provide good (i.e. trustworthy) recommendations. The following modelling parameters are relevant.

OT(SC, SP): this value indicates the level a client SC perceives that the service provider SP is trustworthy because it met its QoS expectations and criteria (i.e., how satisfied SC is by the services SP has provided) after each single interaction.

OD(SC, SP): this value indicates the level a client SC perceives that the service provider SP may not be trustworthy (e.g., the SP obtains its data from a not known source) after each single interaction.

T(SC, SP): this value represents the cumulative trust a SC has on a SP based on the history of interactions SC has with the given SP. The score is computed by considering all previous OT(SC, SP) values.

D(SC, SP): this value represents the cumulative distrust a SC has on a SP based on the history of interactions SC has with the given SP. The score is computed by considering all previous OD(SC, SP) values.

R(SC1, SC2): This value represents the reputation of SC2 as a good recommender as perceived by SC1. The reputation value of client SC2 (i.e. the recommender) is updated every time SC2 recommends a service SP, and SC1 ends up using this service. Said reputation value is indicative of all the discrepancies between the recommendations SC2 has provided to SC1, and SC1's perceived experience after using the service SP.

AR(SC): This value represents the consolidated belief that a client SC is a good recommender given how good its past recommendations were. This overall reputation value is a function of all available R(SCᵢ, SC) values from all nodes SCᵢ which have an R value for SC as a recommender (that is all nodes SCᵢ that have obtained and acted on recommendations from SC in the past).

Experimental Example 1: Recommender Groups. In this example, a client node SCₙ asks for recommendations on services from a set of recommenders S=SCᵣ₁, SCᵣ₂, . . . SCᵣₖ. This set S is composed of:
(a) Expert recommenders, that is the nodes in the network with the highest AR values. The selection threshold can be set as a parameter (e.g. the nodes at the top 10 percentile of AR values, or just the top 20 nodes with the highest AR values). The threshold does not affect the overall behaviour of the technique, as it merely allows for more (or less) recommenders to participate in any given recommendation request.
(b) Friends, that is nodes from which node SCₙ has obtained recommendations in the past. In FIG. 5 nodes SC4 and SC5 are friends to SC1 as both of them have provided recommendations to SC1 in the past.
(c) Friends-of-friends, that is nodes from which friend nodes have obtained recommendations. Thus, friends-of-friends are selected from a set composed of all two-node paths (i.e., a two-node orbit) from SCₙ. In FIG. 5 node SC2 is a friend of friend of SC1, as SC2 has provided recommendations to SC5 and SC5 has provided recommendations to SC1 in the past.

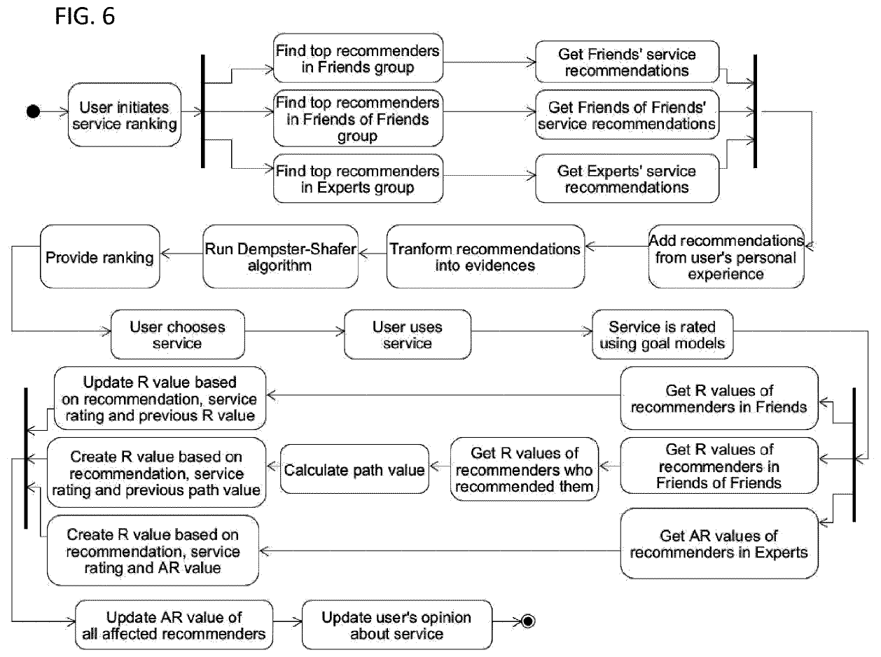

Experimental Example 1: Process Overview. A process of computerized interaction during a session where a client/requester wishes to use a service is depicted in FIG. 6 and can be broken down into ten steps as follows:

Step 1: the client queries a network of interacting entities for a type of service (for example a payment service, a cloud service, or a retail service) and expects to be provided with a list of available services ranked based on the trustworthiness of possible services. This can be done as part of a more complex historical interaction the client engages in already, or as a new interaction. In one example, the client's query/request may be manifested by an electronic submission form as the one presented in FIG. 13 where the client sets parameters for their request (e.g. performance, security, reliability, cost, service hosting location, among others).

Step 2: the top ranked recommenders from each of the recommender groups (best recommenders overall, friends, friends-of-friends) are selected and their service recommendations are collected.

Step 3: the client's opinions, pertaining to previous interactions with the services, are added to the pool of values obtained from the recommenders.

Step 4: the set of recommendations is transformed into a set of positive and negative evidences in a format suitable for an algorithm combining positive and negative evidences, such as the Dempster-Shafer algorithm[28].

Step 5: an algorithm to combine positive and negative evidences is applied, and a ranking of the services is provided to the client. For this exemplification and for illustration purposes the Dempster Shafer theory of evidence algorithm is used. The client is presented with a ranked list of possible services. The list can be communicated to the client in various electronic forms (XML, text, JSON etc.). In one example, such as the one shown in FIG. 14 the client is presented with a table of ranked services. In another example, the client may opt to choose a service which does not have high enough ranking to make it to the list (possibly due to the fact it is a new service and not have built yet a trustworthy QoS performance), but offers an incentive to the client to select it. An example incentive could be extended time of use, reduced usage cost, or promise of future benefits.

Step 6: the client chooses their preferred service and proceeds with the utilization of said service.

Step 7: data are collected from the interaction, either automatically or through user feedback, and an appropriate goal model is used to evaluate the observed T and D values (i.e., the OT and OD values).

Step 8: for every recommender that endorsed the utilized service, their R value is updated as provided in Algorithm R presented below.

Step 9: recalculation of the corresponding AR value is triggered for every updated R value as provided in Algorithm AR presented below.

Step 10: the client's opinion about the utilized service is updated as provided in Algorithm T-D presented below. The client assesses the QoS it experiences after using the service. In one example, the client can fill in a form as the one presented in FIG. 15. In another example, the assessment can happen automatically by observing the behavior of the service and comparing it at run-time, or off-line, against the client's requirements and intents which can be modelled by various means such as Goal Models. The client's opinion may be adjusted by compensations the service provider can offer to mitigate for any occasional reduced QoS the client may have suffered during their interaction.

Experimental Example 1: Algorithm 1—perceived QoS T and D Values. The purpose of this algorithm is to assign a new T(p, s) value which denotes how satisfied the service client p is after using the service s, (i.e., the value of trust p places now on service s after using it) and a new D(p, s) value which denotes the measure of dissatisfaction/distrust client p has on s. Note that a client p will provide two values upon using a service s. The first value indicates how satisfied p is by using s (i.e., the degree p feels s is trustworthy, i.e., s meets p's expectations). This value is denoted by OT(p, s). The second value indicates how dissatisfied p is by using s (i.e., the degree p feels s did not meet its expectations). The second value is denoted by OD(p, s). OT and OD are independent variables, and therefore the sum of OT and OD does not have to add up to 1 or any other constant or fixed value. The values of OT and OD are used to calculate the T and D values respectively. The T and D values are functions of the satisfaction and dissatisfaction the client p has by, a) actually using the service (see OT and OD values) and; b) the current values of T and D prior to p using the service s. The new T and D values replace the old ones, and they become the new current values T and D the client p has for service s. Even though a person of skill in the art can devise a plurality of variant algorithms to achieve the intended behaviour and semantics of determining T and D values, a concrete algorithm is given in Algorithm 1 as a non-limiting illustration.

Algorithm 1: Calculate T-D values.

```
- Let s be a service provider.
- Let p be the client/requester using service s.
-  Let T(p, s) and D(p, s) be the values indicating how trustworthy and untrustworthy,
respectively, p perceives s to be when it comes to providing its service (i.e., it is the value T
for service s prior of p using s).
- Let OT(p, s) and OD(p, s) be the measures that service s is trustworthy and untrustworthy,
respectively, as was actually observed by p when using service provided by s.
- Let c be a parameter indicating the importance of new observations taking values in the
interval (0,1) with c = 0 indicating that new values have no meaning and c = 1 indicating that
the latest value is the only one that matters.
procedure CALCULATE TD(OT,OD)
  T(p, s) = getTvalue(p, s)
  if T(p, s) not available then
    Tnew(p, s) = OT(p, s)
  else
    Tnew(p, s) = (1 − c)T(p, s) + cOT(p, s)
  end if
  T(p, s) = Tnew(p, s)
  saveTvalue(T(p, s))
  D(p, s) = getDvalue(p, s)
  if D(p, s) not available then
    Dnew(p, s) = OD(p, s)
  else
    Dnew(p, s) = (1 − c)D(p, s) + cOD(p, s)
  end if
  D(p, s) = Dnew(p, s)
  saveDvalue(D(p, s))
end procedure
```

The operations getTvalue(p, s), getDvalue(p, s), saveTvalue(T(p, s)) and saveDvalue(D(p, s)) are used to acquire or passivate the required information in a manner consistent with the specific deployment scenario. In a centralized architecture, the functionality can be achieved by the client accessing a database or a repository maintained by the central authority. In a distributed architecture, messages could be broadcasted to the participating entities requesting the information. In case the implementation utilizes underlying blockchain technology, the aforementioned operations will query, or alter respectively, the distributed ledger provided.

Experimental Example 1: Algorithm 2—node-specific reputation as recommender R-Value. The purpose of this algorithm is to assign a score (R value) which denotes how much trust a service client SCₚ places on the recommendation SCᵣ has provided about service s. This score is denoted as R(SCₚ, SCᵣ). More specifically the scenario is that, SCₚ asked SCᵣ for a recommendation about services of a specific type (i.e. process monitoring services), SCᵣ has provided recommendation for service s (see D(SCᵣ, s), and T(SCᵣ, s) values), SCₚ has used the service s as a result of this recommendation, SC, has now first-hand experience about s's behavior (see OT(SCₚ, s), and OD(SCₚ, s) values), and now SCₚ can form an opinion of how good SCᵣ's recommendation finally was (i.e., how trustworthy SCᵣ was as a recommender for recommending service s). The R value R(SCₚ, SCᵣ) of node SCₚ for node SCᵣ fluctuates over time depending the recommendations SCᵣ provides to SCₚ. The R values of all nodes wᵢ which have formed an opinion about SCᵣ (i.e., have R(SC_{wi}, SCᵣ) values) are used to re-calculate the AR(SCᵣ) (i.e., SCᵣ's global/overall ability as a recommender).

Note that in each case, the baseline value, on which the calculated offset is applied, is different, based on the type of recommender, i.e., the recommender group they belong to. The AR value is used for Experts, the R value is utilized for Friends and the product of R values along the path are considered for Friends-of-Friends (i.e., R(p, friend)*R(friend, friendOfFriend)). The offset is also adjusted accordingly for each step in the latter scenario.

Different approaches have been proposed regarding propagation of trust in social graphs [26]. A choice to use the multiplication norm in the friend of friend scenario resonates more with the world we are trying to approximate through our approach. Even though a person of skill in the art can devise a plurality of variant algorithms to achieve the intended behaviour and semantics of this step, a concrete algorithm is given in Algorithm 2 below as a non-limiting illustration. Note that the intent of Algorithm 2 is to update a recommender reputation whereby if a recommender had provided a recommendation which aligns with the experience a client has experienced after using a service, then the reputation this client has for this recommender (i.e. R(p, r) value increases, otherwise it decreases.

Algorithm 2: Calculate R value.

```
- Let p be the client/requester node that is asking for recommendations of services.
- Let r be the recommender node that is recommending a service.
- Let T(r,s) and D(r, s) be the trust and distrust values, respectively, given by r for service s.
- Let OT(p,s) and OD(p, s) be the measures that service s is trustworthy and untrustworthy,
respectively, as was actually observed by p after it used the service s.
- Let R(p, r) be the trust of p to r after the calculation /* i.e how much p now believes that r
is a good recommender */
- Let error be the difference between observed and provided trust and distrust.
- Let offset be the offset that is to be applied to the trust in r's recommendations based on
new data.
procedure CALCULATE R(OT,OD)
    T(r, s) = getTvalue(p, s)
    D(r, s) = getDvalue(p, s)
    error = |T(r, s)−OT(p, s)| + |D(r, s) − OD(p, s)|
    offset = 0.1 * [ 2 / {1+e⁽²⁰*^{(error-0.1))}} − 1]
    if r in expert nodes then
      /* that is r is in the top of the list of recommenders ranked by AR value */
      AR(r) = getARvalue(r)
      baseline(p, r) = AR(r)
    end if
    if r is friend of p then
      /* that is r is in the top of the list of recommenders ranked by their R value
    provided by p */
      R(p, r) = getRvalue(p, r)
      baseline(p, r) = R(p, r)
    end if
    if r is a friend of friend k of p then
      /* that is r is in the top of the list of recommenders ranked by the cross
  product of R values provided by p and its friends, in all two-step paths emanating
  from p */
      R(p, k) = getRvalue(p, k)
      R(k, r) = getRvalue(k, r)
      baseline(p, r) = (R(p, k) * R(k, r))
    end if
    R(p, r) = baseline(p, r) + offset
    saveRvalue(R(p, r))
    Recalculate the existing value of AR(r)
end procedure
```

The operations getTvalue(p, s), getDvalue(p, s), getARvalue(r), getRvalue(p, r), getRvalue(p, k), getRvalue(k, r), saveRvalue(T(p, r)) are used to acquire or passivate the required information in a manner consistent with the specific deployment scenario. In a centralized architecture, the functionality can be achieved by the client accessing a database or a repository maintained by the central authority. In a distributed architecture, messages could be broadcasted to the participating entities requesting the information. In case the implementation utilizes underlying blockchain technology, the aforementioned operations will query, or alter respectively, the distributed ledger provided.

### Experimental Example 1: Algorithm 3—Overall Reputation as a Recommender AR-Value

The purpose of this algorithm is to assign to a node r (i.e., a service client who may act at a particular time as a recommender) its AR value, that is the overall reputation of this node as recommender. The AR(r) value increases or decreases over time depending of what recommendations node r has given for a service s compared to the experiences of other nodes which have used the service s. If the recommendations provided by r are consistent with the experiences of other nodes who have used the service as a result of r's recommendations, the r's AR value increases, otherwise decreases. The AR(r) value is a function of the collective belief of all other individual nodes w that r is a good recommender. This collective belief is formulated after all such nodes w have accepted recommendations from r in the past for service s and also have first-hand experience by using service s (possibly as a result of r's recommendation). Even though a person of skill in the art can devise a plurality of variant algorithms to achieve the intended behaviour and semantics of this step, a concrete algorithm is given in Algorithm 3 below as a non-limiting illustration. For example, instead of using a cumulative sum of the product of R and AR value one skilled in the art could use, among others, a weight function, a fuzzy score, or a rule-based system.

Algorithm 3: Calculate AR value.

```
- Let r be the recommender node whose overall recommendation capability is AR(r).
- Let Nᵣ be the set of nodes having node-to-node recommendation strength values R for
recommender r.
- Let R(w, r) be the node-to-node recommendation strength w has assigned so far to r.
- Let sum = 0
procedure CALCULATE AR(Nᵣ,R[size(Nᵣ)])
  Nᵣ = getRecommendersOf(r)
  for each client node w in Nᵣ do
    AR(w) = getARvalue(w)
    if AR(w) is not available then
      AR(w) = 0.5
    end if
    sum = sum + (R(w, r) * AR(w))
  end for
  AR(r) = sum/cardinality(Nᵣ)
  saveARvalue(AR(r))
end procedure
```

The operations getRecommendersOf(r), getARvalue(w), and saveARvalue(r) are used to acquire or passivate the required information in a manner consistent with the specific deployment scenario. In a centralized architecture, the functionality can be achieved by the client accessing a database or a repository maintained by the central authority. In a distributed architecture, messages could be broadcasted to the participating entities requesting the information. In case the implementation utilizes underlying blockchain technology, the aforementioned operations will query, or alter respectively, the distributed ledger provided.

Experimental Example 1: evaluation of OT and OD values. The OT and OD values (see T-D and R algorithms) denote how a service client assesses its level of satisfaction through a specific interaction with the particular service. More specifically, the OT value denotes the measure of how much the service client believes the service met its expectations (e.g., QoS metrics, constraints, requirements, etc.). Similarly, the OD value denotes the measure of how much the client believes that the service engaged in behaviors that may signify distrust towards the service (e.g., failed to meet one or more of the client's intended requirements or QoS metrics). For example, data acquisition from a nonauthorized source, where the provenance of the obtained data is questionable, would increase this OD value. Clients can set specific requirements models pertaining both to trust and distrust of a service. The use of these pair-values (trust OT and, distrust OD) allows for a more flexible model where a client can provide at the same time the positive and negative aspects related to its observations when using a service. The value of OT ranges from 0 to 1 (0 meaning the service did not meet its expectations, and 1 the service fully met its expectations). For example, an OT value of 0.8 indicates the level the client believes that the service met its expectations in a satisfactory degree. The value of OD also ranges from 0 to 1 (0 meaning that the client agrees that the service did not engage in any behavior increasing distrust, and 1 meaning that the client observed service behavior indicating full distrust). For example, an OD value of 0.2 indicates the level the client believes that the service engaged in behavior that slightly increases distrust. The OT and OD values do not need add to 1 or any other fixed or constant value. The proposed technique does not place any constraint on the method to be used by a client to assign OT and OD values after its interaction with a service. These may include fuzzy logic, statistical analysis, probabilistic reasoning etc. For the prototype implementation, a client sets its expectations from the service in the form of models, such as goal models [29], which are evaluated using a fuzzy reasoner in order to assess how well the service performed based on the requirements [30].

Experimental Example 1: ranking of proposed services. 1) Selection of recommenders: When a client/requester component p seeks information about service providers sₘ, . . . sₙ can request from a collection of other client recommender components rᵢ, . . . rⱼ a score for these services. Each recommender rᵢ, . . . rⱼ provides a [symbol] T,D [symbol] pair of values for each service sₘ, . . . sₙ for whom has values for. Each value supplied is considered as a distinct evidence, to be used as input to an algorithm that combines positive and negative evidence as per the theory of reasoning models of evidential strength [32]. A person of skill in the art can devise a plurality of variant algorithms to achieve the intended behaviour and semantics of this step. Such algorithms can utilize rules, tables, probabilistic reasoning, statistical reasoning, or machine learning algorithms, among others, without affecting the nature and the intent of this step. In this exemplification we use the Dempster-Shafer theory of evidence algorithm [28].

These recommenders rᵢ, . . . rⱼ are consulted by client p using the following three strategies:
i) Select the top A % of recommenders rₖ to which p has an R(p, rₖ) value (i.e., has received recommendations from them in the past). This is the group of Friends.
ii) Select the top A % of recommenders r, to which any recommender rₖ who p has an R(p, rₖ) value (i.e., has received recommendations from them in the past), has also an R(rₖ, r_{w}) value themselves (i.e., rₖ has received recommendation(s) from r_{W} in the past). This is the group of Friends-of-Friends that is found within nodes having a two degree of separation from p.
iii) select the top A % of recommenders r, with the highest AR(r,) value in the system. This is the group of Experts.

The parameter A can be set based on the distribution of R values a client p has on a potential recommender r_{w} (and their friends), and the AR values appearing on the system. Note that a higher value of A will result in getting the opinion of more recommenders into account. However, the value of this parameter does not affect the semantics of the proposed approach. All available recommendations about service providers are obtained by the recommenders participating in one of those groups. If available, personal experience of p for a service provider s is, also, taken into consideration and ratings of service providers used in the past are obtained as well.

2) Dempster-Shafer: The Dempster-Shafer theory of evidence is used to provide a final ranking of services based on all recommendations (T and D values) obtained. The proposed system considers every T value produced as an ‘in-favor’ evidence for a service s, and a D value as an ‘against’ evidence for a service s, or complimentary as an ‘in-favor’ evidence for the set of all available services except s. These evidences are aggregated using the Dempster-Shafer evidence theory algorithm to provide an overall belief interval for each recommended service, given the ‘in-favor’ and ‘against’ values for each service. This exemplification using the Dempster-Shafer evidence theory algorithm does not place any restriction on which variant algorithm can be used for combining positive and negative evidence into an aggregate score. A person of skill in the art can utilize rules, tables, probabilistic reasoning, statistical reasoning, or machine learning algorithms, among others, without affecting the nature and the intent of this step. These types of algorithms that combine positive and negative evidences into an aggregate score have been discussed in the related literature and are considered as reasoning models of evidential strength [32].

Experimental Example 1: self-regulating behavior of recommenders. Case 1: Recommenders r who recommend correctly to requester p. The R(p,r) value from p to these recommenders r will increase whenever p ends up acting upon r's recommendation. This will trigger the re-calculation of r's AR value, causing it to increase, making it an even more reputable recommender.

Case 2: Malicious or erroneous recommenders r. These recommenders r may maliciously degrade their recommendation towards a service s, to a node p1 seeking recommendation. However, other nodes r1, r2, r3, . . . , who are not malicious may also be providing a good recommendation for s to p1, which in this case p1 may decide to use s. If p1 decides to use s, then a discrepancy between r's recommendation and p1's observed value of s's QoS will occur, thus reducing p1's node-to-node recommendation strength R towards r, causing r's AR to be reduced as well. While successful operation of the network is not limited to any particular range or threshold of network density (as a measure of the number of interacting entities in the network), a positive correlation between resilience to malicious recommenders and network density has been observed. For example, the denser the network becomes the higher the chances that p1 will be connected to other nodes r1, r2, r3, . . . , and not only r, thus exposing r's malicious behavior. In a similar example, the denser the network becomes the higher the chances that p1 will be connected to other nodes r1, r2, r3, . . . , and not only r, so as to reduce impact of a malicious recommender that increases its recommendation (i.e., maliciously increase a T value and/or maliciously decreases a D value) for a non-trustworthy service.

Case 3: Service client r who observes correctly and calculates T and D values correctly. When these clients r are asked for their recommendation by a potential service client p, they will provide a correct recommendation, and thus the R value towards them by p will increase, causing r's AR to increase, making r a reputable future recommender. Then this becomes equivalent to Case 1 above.

Case 4: Malicious service client r who observe and calculate T, and D values erroneously. When these clients r are asked for their recommendation by a potential service client p, they will provide an incorrect recommendation, and thus the R value towards them by p will decrease, causing r's AR to decrease, making r a non-reputable future recommender. Then this becomes equivalent to Case 2 above.

While successful operation of the network is not limited to any particular range or threshold of network density (as a measure of the number of interacting entities in the network), as the network grows and more nodes have access to more recommenders, the system and method will typically provide greater stability in the presence of malicious nodes.

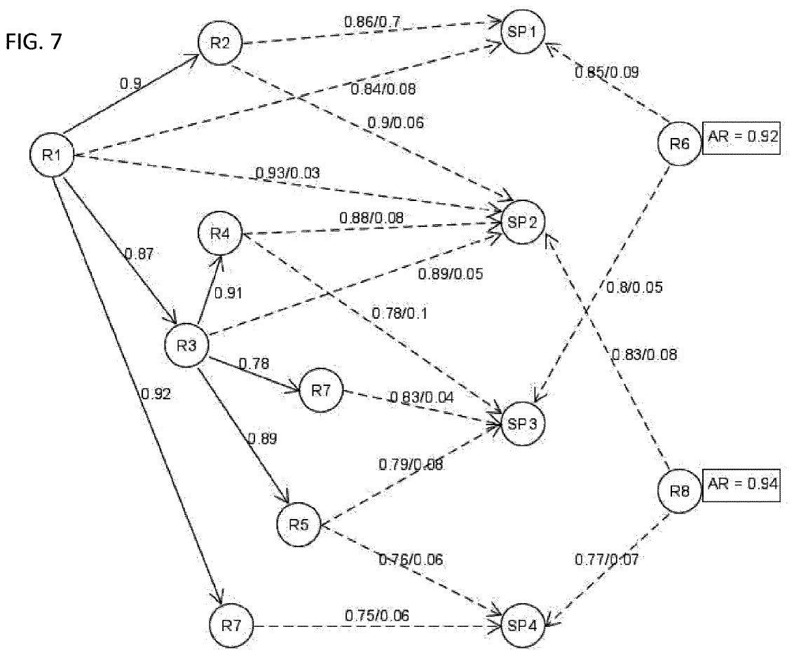

Experimental Example 1: running example. To further clarify the method and system described herein, a running example is presented. This running example aims to illustrate the computation of the ranking of a service and the update of the reputation of a recommender and service nodes after utilization of a service. The subset of the network involved in this scenario is portrayed in FIG. 7. We assume the percentage of recommenders chosen per recommender group corresponds to 2 recommenders per group to simplify the example. Following the steps described above in the Process Overview section:

Step 1: User R1 initiates process.

Step 2: Recommender groups are created as follows:
the system investigates the R values of all of R1's friends (directly neighboring nodes to R1) and finds that among R2, R3, R7, the ones with the highest values are R2 and R7, with their R values being 0.9 and 0.92 respectively.
All available 2-step paths are then explored looking for the 2 with the highest value. The paths with the highest value are the ones going to R4 and R5 through R3 with corresponding values of 0.7917 and 0.7743.
Finally, the system inspects the AR values of all available recommenders. Let's assume that R6 and R8 have the highest values of 0.92 and 0.94 respectively. At the end of this step, we have Friends=R2, R7, FriendsOfFriends=R3-R4, R3-R5 and Experts=R6, R8. Recommendations about services SP1, SP2, SP3 and SP4 are provided by them.

Note that, even though a service SP5 might be part of the system, it might not be recommended by any of the top recommenders, in which case it is not included in the following steps.

Step 3: For each service and each group, we aggregate the values, if multiple are available. The calculations for each service and group are as follows:
SP1: Recommendations from the Friends and Experts groups are available. More specifically, the following values are available:

$$T ( R 2 , S P 1 ) = 0.86 / D ( R 2 , S P 1 ) = 0.7$$

$$T ( R 6 , S P 1 ) = 0.85 / D ( R 6 , S P 1 ) = 0.09$$

SP2: Recommendations from the Friends, FriendsOfFriends and Experts groups are available. More specifically, the following values are available:

$$T ( R 2 , S P 2 ) = 0.9 / D ( R 2 , S P 2 ) = 0 \text{.06}$$

$$T ( R 4 , S P 2 ) = 0.88 / D ( R 4 , S P 2 ) = 0.08$$

$$T ( R 8 , S P 2 ) = 0.83 / D ( R 8 , S P 2 ) = 0.08$$

SP3: Recommendations from FriendsOfFriends and Experts groups are available. More specifically, the following values are available:

$$T ( R 4 , S P 3 ) = 0.78 / D ( R 4 , SP 3 ) = 0.1$$

$$T ( R 5 , S P 3 ) = 0.79 / D ( R 5 , S P 3 ) = 0.08$$

$$T ( R 6 , S P 3 ) = 0.80 / D ( R 6 , S P 3 ) = 0.05$$

SP4: Recommendations are available from Friends, FriendsOfFriends and Experts groups, so:

$$T ( R 7 , S P 4 ) = 0.75 / D ( R 7 , S P 4 ) = 0.06$$

$$T ( R 5 , S P 4 ) = 0.76 / D ( R 5 , S P 4 ) = 0.06$$

$$T ( R 8 , S P 4 ) = 0.77 / D ( R 8 , S P 4 ) = 0.07$$

Step 4: The requesting user R1 has recommendations for SP1 and SP2, providing the following values:

$$T ( R 1 , SP 1 ) = 0.84 / D ( R 1 , SP 1 ) = 0.08$$

$$T ( R 1 , SP 2 ) = 0.93 / D ( R 1 , SP 2 ) = 0.03$$

Step 5: All T values are considered evidences in favour of that service and all D values are considered against, meaning they are in favour of the set of all remaining available services.

Step 6: After running the Dempster-Shafer algorithm, a list with the services is returned. In this scenario the list ranked from highest to lowest is: [SP2, SP1, SP3, SP4].

Step 7: Let's assume the user R1 uses the service with the highest ranking, i.e., SP2.

Step 8: The chosen service is used, and the appropriate goal model is run to evaluate its performance. In this example let's assume OT=0.91, OD=0.04.

Step 9: The recommenders that endorsed SP2 are R2, R4, R8. Their new R values are computed as follows:
For R2:

$$error = \vert T ( R 2 , SP 2 ) - OT \vert + \vert D ( R 2 , SP 2 ) - OD \vert = 0. 01 + 0.02 = 0 \text{.03}$$

$$offset = 0.1 * [ 2 / \{ 1 + {e}^{( {20}_{*} ( error - 0.1 ) )} \} - 1 ]$$

$$R ( R 1 , R 2 ) = R ( R 1 , R 2 ) + offset = 0.9 + 0.06 = 0.96$$

For R4:

$$error = \vert T ( R 2 , SP 2 ) - OT \vert + \vert D ( R 2 , SP 2 ) - OD \vert = 0.03 + 0.04 = 0.07$$

$$offset = 0.1 * [ 2 / \{ 1 + {e}^{( {20}_{*} ( error - 0.1 ) )} \} - 1 ]$$

$$R ( R 1 , R 4 ) = R ( R 1 , R 3 ) * R ( R 3 , R 4 ) + offset = 0.7917 + 0.029 = 0.8208$$

For R8:

$$error = \vert T ( R 8 , SP 2 ) - OT \vert + \vert D ( R 8 , SP 2 ) - OD \vert = 0.08 + 0.04 = 0.12$$

$$offset = 0.1 * [ 2 / \{ 1 + {e}^{( {20}_{*} ( error - 0.1 ) )} \} - 1 ]$$

$$R ( R 1 , R 8 ) = AR ( R 8 ) + offset = 0.94 - 0.02 = 0.92$$

Step 10: The AR values are recalculated for R2, R3, R8 according to Algorithm 3.

Step 11: Since the requesting user R1 already had an opinion about SP2, the T and D values can be updated according to Algorithm 1. Assuming that the c parameter is set to 0.1, the new values are calculated as follows:

$$Tnew ( R 1 , SP 2 ) = ( 1 - c ) T ( R 1 , SP 2 ) + cOT = 0.9 \cdot 0.93 + 0.1 \cdot 0.91 = 0.928$$

$$Dnew ( R 1 , SP 2 ) = ( 1 - c ) T ( R 1 , SP 2 ) + cOD = 0.9 \cdot 0.03 + 0.1 \cdot 0.04 = 0.031$$

Note that in Step 9, the offset is sometimes negative and sometimes positive, depending on the discrepancy between observed values and values provided through the recommendation. So, small errors improve a recommender's reputation, whereas larger ones decrease the faith put in their ability to provide recommendations.

### Experimental Example 1: Validation Examples—Experimental Testing

Experiments are performed in order to evaluate the performance and behaviour of the currently exemplified method and system. Service rankings requested by various sources are monitored and juxtaposed with the actual ranking of services based on their predetermined behaviour (i.e., QoS). The experiments focused on a) stability of the system in the presence of malicious recommenders; b) how quickly degrading services are recognized; c) how connections are formed as the system operates; d) how the different types of recommenders (best overall, friends, friends-of-friends) are distributed over time; and e) the importance of having independent trust and distrust values.

1) Experimental Setup. A network of transacting entities is simulated by considering 1,000 recommenders and 100 service providers. Testing and validation of the method and system described herein is not limited to any specific set of parameter and assumptions, and many different combinations of parameters and assumptions may be set to run relevant simulations. For example, the network and experimental setup may be configured to simulate, for comparison purposes, the networks presented in peer-reviewed articles published in the scientific literature and related to this field of study. As a non-limiting illustration, for each run of the system, each recommender was randomly connected to 10 service providers and the initial value was randomized within ±5% of the predetermined value for that particular service. Each recommender node was connected to 10 other recommenders with a random R value between 0.6 and 0.9. Each experiment was run on several iterations and in each iteration a random subset of 5% is considered when executing the process illustrated in the Running Example. We also consider that services would perform within a +/−2% error of their predetermined behavior to account for quality of service variability. Information about the ranking of the services at the end of each iteration was received using three different sources: a) an external user who was only requesting the rankings but never participating in the network (i.e., not using any service and not linked to any nodes/friends, and therefore obtaining rankings by querying expert recommenders only), b) a random subset of the active recommenders that was determined at the beginning of the experiment and then remained fixed throughout the multiple iterations of the experiment, and c) a random subset of the active recommenders that would change at the beginning of every iteration. Before initiating the actual experiments, we performed a process referred to in the literature as bootstrapping. This process ensures that the system can start from a stable state since the initial values between the recommenders were entirely random. Since the R values start with random scores, every set of experiments run five times using the same parameters, and an average of the results was collected for reporting.

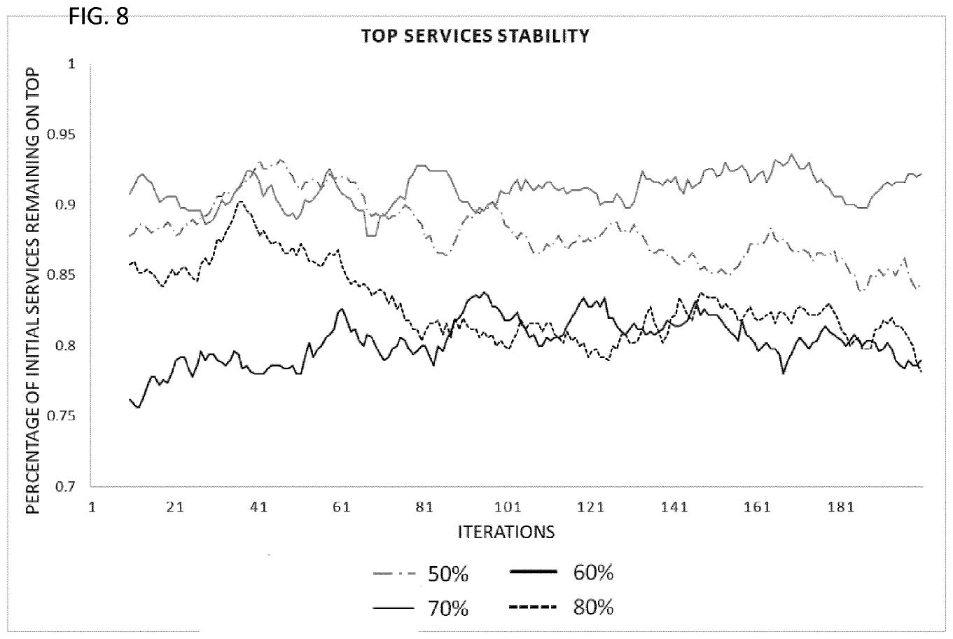

2) Stability in the Presence of Malicious Components. To verify the stability of our approach in the presence of malicious users, several experiments were conducted with various percentages of components providing maliciously false recommendations. Each experiment consisted of 200 iterations as described in Experimental Setup. Users were instructed to turn malicious right after the initial phase. Experiments included 50%, 60%, 70% and 80% of total recommenders being malicious (i.e., knowingly providing false recommendations) in each corresponding set of experiments. For convenience of data interpretation, a moving average of the results of 10 iterations is presented in FIG. 8. The results indicated that the system remains stable even for 80% of users being malicious. The top service providers reported in the rankings deriving from recommendations from all sources are 75-95% the same as the ones reported in the ranking compiled using the predetermined and objective behavior of the available services. The fact that the currently exemplified process provides dynamic assessment of the behavior of both the recommenders and the service providers allows non-malicious users to try, assess and learn from previous experience as to what sources of information are reliable or not. As expected, even for high percentages of malicious users, connections between honest users are strengthened and said users value and rely on the opinions of those they trust to evaluate the degree to which a service provider actually performs as promised. Furthermore, even though it would be tempting to completely exclude the opinion of groups currently deemed dishonest, we allow the user to receive and weigh those opinions, so as to enable the adaptation of our framework to changes in the future.

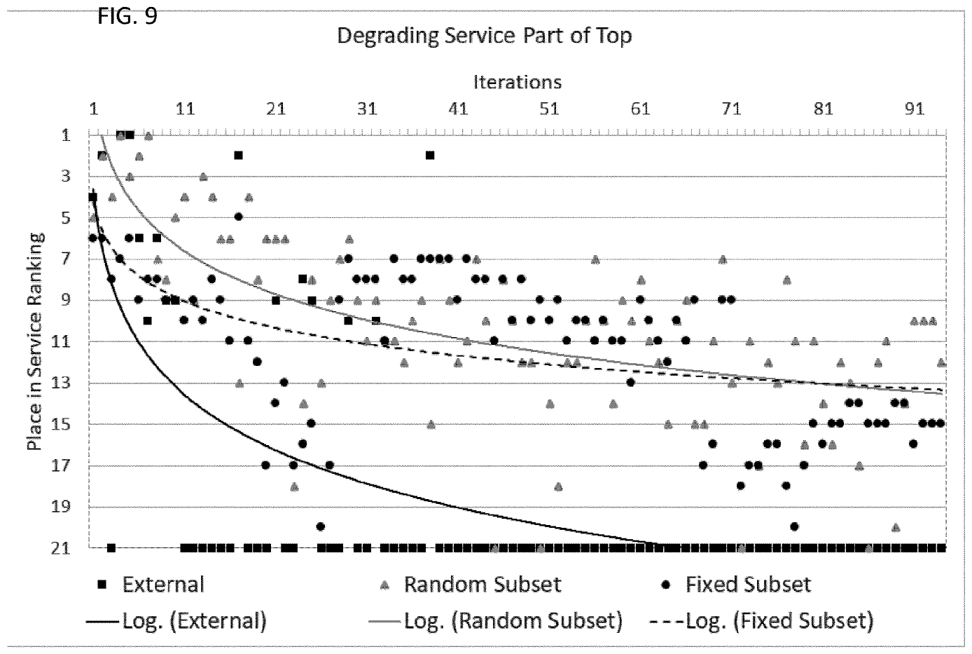

3) Degrading Services. Another set of experiments was run to ensure that our approach adapts to changes in the behavior of a well-established service over time. Since the level of trustworthiness of any service is not guaranteed to remain the same forever, our framework identifies dynamic behavior and allows for adjustment of any service's reputation within the network. This particular scenario, also, covers the possibility of a malicious service provider who might provide high quality service to lure-in potential customers and improve their reputation before deteriorating the quality of offered service and taking advantage of said customers. Experiments were run for as many iterations as required before all three sources of ranking would report that the degrading service is no longer in the top of the retrieved rankings. Results are shown in FIG. 9. We can see that even though the degrading service is at the top of the rankings in the beginning of the experiment, recommenders very quickly realize the degrading QoS and this is reflected in the rankings. In as few as nine iterations, the degrading service is not part of the top 10 of the external user's ranking. Further drop in the rankings requires a bit longer, since most users don't use the service after it drops in the rankings. Another issue to be mentioned regarding this set of experiments is that the external user identifies the degrading service quicker as they only consult the experts of the network (they have no other connection to the network). The random subsets, either the one that is fixed throughout the experiment or the one that changes in every iteration, take longer to figure out that something is wrong, since there might be a few iterations before the majority of their members have used a service. However, the eviction of the degrading service by the subsets is a clear indication that the entirety of the network is now aware of the issue.

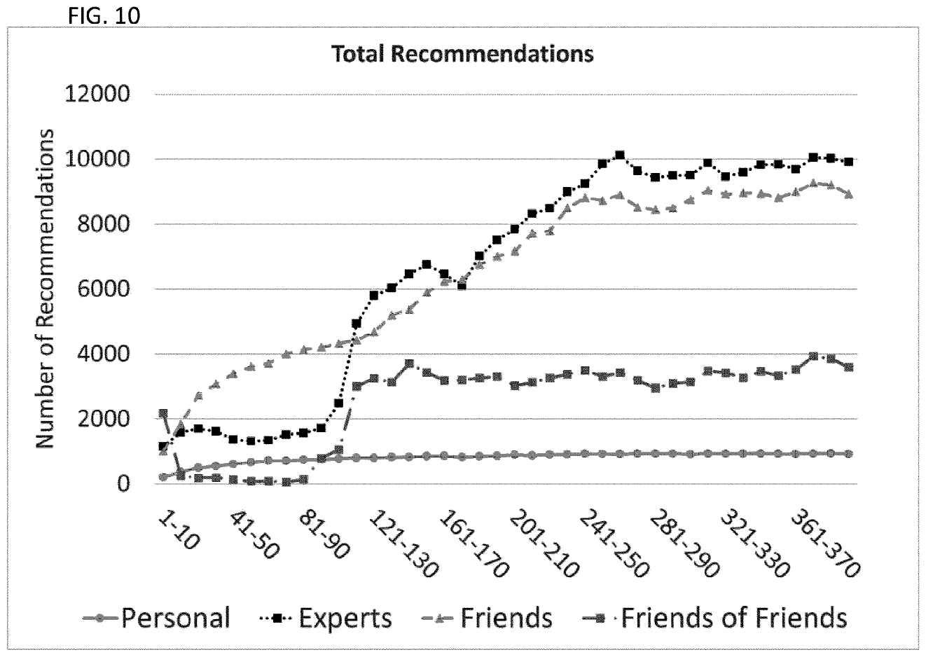

4) Sources of Recommendation. Another interesting dimension of this exemplification is the pluralism of recommendations from a variety of sources. In order to evaluate and assess said polyphony, the nature of the recommenders, and corresponding recommendations that led to the choice of a specific service provider, were identified through yet another set of experiments that consisted of 400 iterations. Results were summed up in intervals of 10 iterations, so as to make the figure more legible. As seen in FIG. 10, recommendations from all types of recommenders are taken into consideration throughout the system's run. Both recommendations stemming from previous personal experience and ones coming from friends-of-friends increase over time, until a certain threshold, specified as a parameter within the framework, is reached. This indicates that the system reaches a stable point where a certain amount of connections has already been made and enough information is derived from such sources. When it comes to friends and experts, however, the numbers mostly follow a pattern that is congruent to the framework's expected behaviour, as opinions from friends and experts depend on the requesting user's actual connections and total connections in the system respectively, which might fluctuate over time. At any point, though, a variety of sources are providing recommendations, allowing the currently exemplified system to adapt to changes in an efficient and adaptive manner.

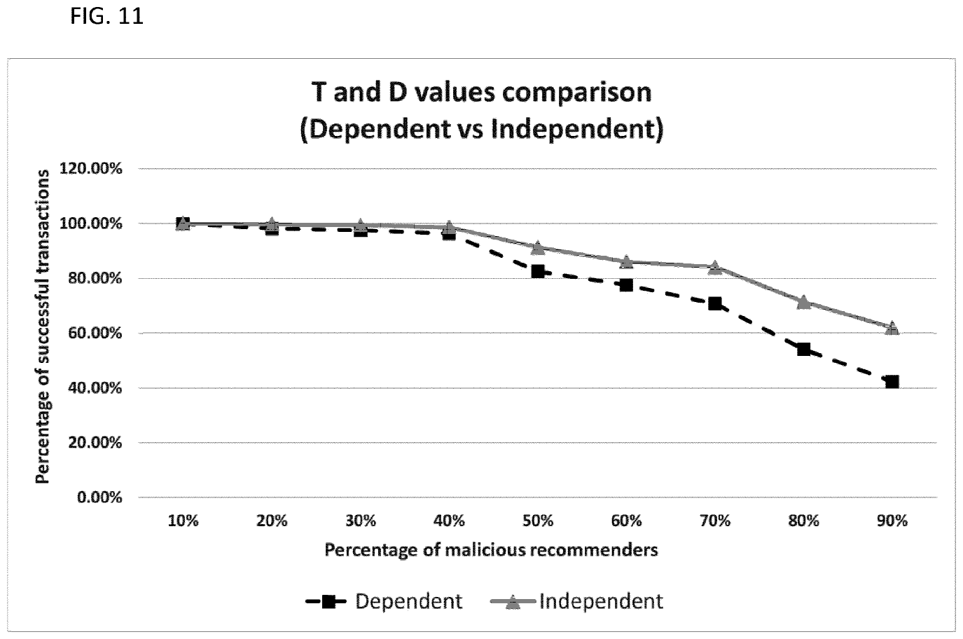

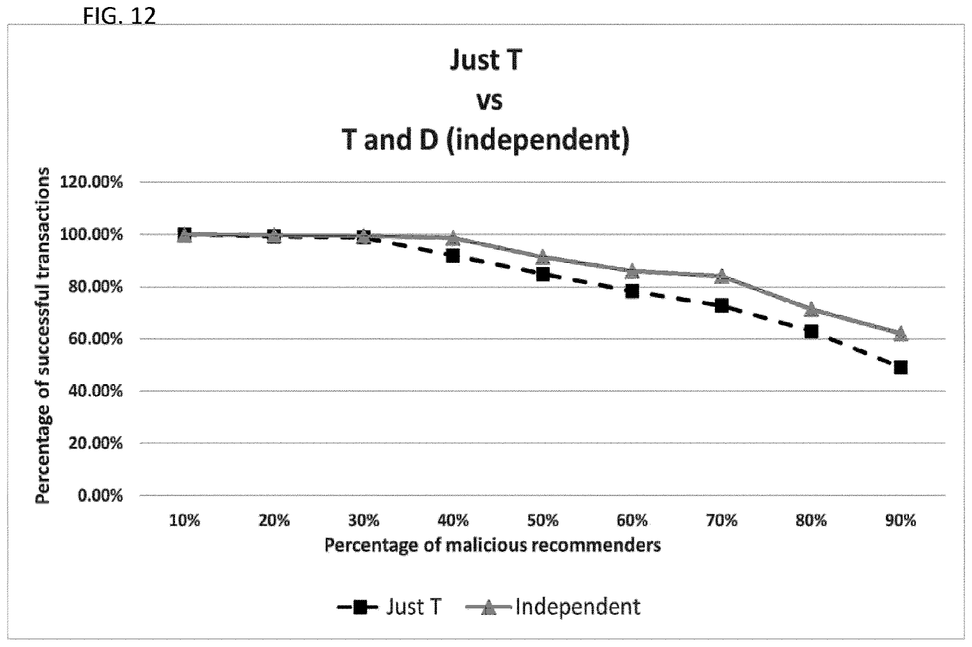

5) Importance of Independent Trust and Distrust Values. To prove the importance and utility of calculating, maintaining and taking into account completely independent trust and distrust values, an additional set of experiments was run. The experimental setup was identical to the one used for the previous experiments and, same as the experiments for verifying stability in the presence of malicious components, each of the experiments consists of 200 iterations and varying percentages of recommenders behaving in a malicious way (ranging from 10% to 90%). The difference pertains to the use of trust and distrust values to evaluate a service provider. The experiments look into two separate hypotheses. On one side, the theory that the utilization of both trust and distrust is preferrable to using just one value is tested. Results are shown in FIG. 11. It is evident that using independent trust and distrust leads to higher percentages of successful transactions, especially when more of the recommenders are behaving in a malicious manner. The hypothesis that having independent (do not sum up to 1) instead of dependent (always sum up to 1) trust and distrust values is also tested. As seen in FIG. 12, treating the two values as independent bears significantly better results when it comes to successful transactions in the presence of malicious recommenders. Both experiments demonstrate a significant advantage of using independent trust and distrust values. The outcome of those experiments has proven that utilizing independent trust and distrust significantly benefits successful transactions in the presence of malicious recommenders.

### Experimental Example 1: Reference List

[1] Kai Hwang et al. Distributed and Cloud Computing: From Parallel Processing to the Internet of Things, Morgan Kaufmann publishers, 1st edition (2011).
[2] Giamanco; Barbara; Gregoire, Kent (2012). “Tweet me, friend me, make me buy” (PDF). Harvard Business Review. 90 (7): 89-93. Archived from the original (PDF) on 2014 Dec. 13.
[3] Jensen, C. D. (2014). The Importance of Trust in Computer Security. In: Zhou, J., Gal-Oz, N., Zhang, J., Gudes, E. (eds) Trust Management VIII. IFIP™ 2014. IFIP Advances in Information and Communication Technology, vol 430. Springer.
[4] Rose, Scott, et al. Zero trust architecture. No. NIST Special Publication (SP) 800-207. NIST, 2020.
[5] Lv, S., Li, H., Wang, H., Wang, X. (2020). CoT: A Secure Consensus of Trust with Delegation Mechanism in Blockchains. In:, et al. Blockchain Technology and Application. CBCC 2019. Communications in Computer and Information Science, vol 1176. Springer.
[6] Jennings, N. R. (2002). Agent-Based Computing. In: Musen, M. A., Neumann, B., Studer, R. (eds) Intelligent Information Processing. IIP 2002. IFIP The International Federation for Information Processing, vol 93. Springer, Boston, MA.
[7] Park M. and Kim Y-G, A Metaverse: Taxonomy, Components, Applications, and Open Challenges. In IEEE Access, vol. 10, pp. 4209-4251, 2022.
[8] H. Yu, et al., A Survey of Multi-Agent Trust Management Systems. In IEEE Access, vol. 1, pp. 35-50, 2013.
[9] S. D. Kamvar et al., The eigentrust algorithm for reputation management in P2P networks, in: Proceedings of the Twelfth International Conference on World Wide Web, ACM, 2003, pp. 640-651.
[10] Page, L., et al.: The PageRank Citation Ranking: Bringing Order to the Web. Tech. Report, Stanford Digital Library Tech. Project (1998).
[11] Zhou, R., Hwang, K.: Powertrust: a robust and scalable reputation system for trusted peer-to-peer computing. IEEE Trans. Parallel Distributed Syst. 18(4).
[12] Damiani, E., et al.: A reputation-based approach for choosing reliable resources in peer-to-peer networks. In: ACM Conf. on Computer and Communications Security, pp. 207-216 (2002).
[13] Sabater, J., Sierra, C.: Reputation and social network analysis in multi-agent systems. In: Proc. of the first Intl. Joint Conf. on Autonomous Agents and Multiagent Systems, pp. 475-482, Bologna, Italy (2003).
[14] Aberer, K., Despotovic, Z.: Managing trust in a peer-2-peer information system. In: CIKM, pp. 310-317 (2001).
[15] C. Tian, B. Yang, R2Trust: a reputation and risk based trust management framework for large-scale, fully decentralized overlay networks, Fut. Gen. Comput. Syst. 27 (2011) 1135-1141.
[16] Z. Q. Liang, W. S. Shi, PET: a personalized trust model with reputation and risk evaluation for P2P resource sharing, in: Proceedings of the 38^{th} International Conference on System Science, Hawaii, USA, 2005.
[17] S. S. Song, K. Hwang, R. F. Zhou, Trusted P2P transactions with fuzzy reputation aggregation, IEEE Internet Computing (2005) 18-28.
[18] M. Wang, F. Tao, Y. Zhang, G. Li, An adaptive and robust reputation mechanism for P2P network, in: Proceedings of the IEEE International Conference on Communications, Cape Town, South Africa, 2010.
[19] Buchegger, S., Le Boudec, J.-Y.: Performance analysis of the CONFIDANT protocol. In: Proc. of the 3rd ACM Intl. Symposium on Mobile Ad Hoc Networking and Computing, pp. 226-236, June 9-11 (2002).
[20] Rocha, B. G., Almeida, V., Guedes, D.: Increasing qos in selfish overlay networks. IEEE Internet Comput. 10(3), 24-31 (2006).
[21] Maximillien, E. M., Singh, M. P.: Conceptual model of web service reputation. SIGMOD Record 31(4), 36-41 (2002).
[22] Maximilien, E. M., Singh, M. P.: A framework and ontology for dynamic web services selection. IEEE Internet Comput. 8(5), 84-93 (2004).
[23] Maximilien, E. M., Singh, M. P.: Toward autonomic web services trust and selection. In: ICSOC 2004: Proceedings of 2nd International Conference on Service Oriented Computing, November (2004).
[24] Maximilien, E. M., Singh, M. P.: Agent-based trustmodel involving multiple qualities. In: Proc. of 4th International AAMAS, July (2005).
[25] Z. Malik, A. Bouguettaya, RATEWeb: reputation assessment for trust establishment among web services, VLDB J. 18 (2009) 885-911.
[26] R. Guha, et al., Propagation of trust and distrust, in: Proc. of the 13th Intl. Conference on World Wide Web, 2004, pp. 403-412.
[27] P. Bonacich, P. Lloyd, Eigenvector-like measures of centrality for asymmetric relations, Soc. Netw. 23 (2001) 191-201.
[28] Glenn Shafer, A mathematical theory of evidence, Princeton Univ. Press, Princeton, New Jersey, 1976.
[29] Horkoff J, et al. Goal-oriented requirements engineering: an extended systematic mapping study. Requir Eng. 2019; 24(2):133-160.
[30] G. Chatzikonstantinou, K. Kontogiannis: Efficient parallel reasoning on fuzzy goal models for run time requirements verification. Softw. Syst. Model. 17(4).
[31] R. Urena, F. Chiclana, E. Herrera-Viedma, DeciTrustNET: A graph based trust and reputation framework for social networks, Information Fusion, Vol. 61, 2020, pp. 101-112.
[32] Artificial Intelligence (3rd Edition), P. H. Winston, Pearson, 1992.
[33] Lowd Daniel and Domingos Pedro”. 2007. Efficient Weight Learning for Markov Logic Networks. In Knowledge Discovery in Databases: PKDD 2007, Kok Joost N., Koronacki Jacek, Lopez de Mantaras Ramon, Matwin Stan, Mladenič Dunja, and Skowrons Andrzej (Eds.). Springer Berlin Heidelberg, Berlin, Heidelberg, 200-211.
[34] Buchanan, B. G., Shortliffe, E. H. (Eds.), Rule-Based Expert Systems: The MYCIN Experiments of the Standord Heuristic Programming Project, Addison-Wesley, Reading, MA.
[35] P. J. Denning, “Working sets past and present,” IEEE Trans. Software Engineering, vol. SE-6, no. 1, pp. 64-84, 1980.
[36] A. V. Aho, P. J. Denning, and J. D. Ullman, “Principles of optimal page replacement,” J. ACM, vol. 18, no. 1, pp. 80-93, 1971.
[37] Megiddo, Nimrod and Dharmendra S. Modha. “ARC: A Self-Tuning, Low Overhead Replacement Cache.” FAST (2003).

An illustrative version and several variants of methods and systems for reducing impact of malicious agents/actors in a network of interacting entities have been described above without any intended loss of generality. Further examples of modifications and variation are now provided. Still further variants, modifications and combinations thereof are contemplated and will be apparent to the person of skill in the art. It is to be understood that illustrative variants or modifications are provided for the purpose of enhancing the understanding of the person of skill in the art and are not intended as limiting statements.

The methods and systems described herein allow for physical and digital entities to exchange information so that a network of clients and recommenders which trust a collection of service providers can be established and dynamically evolved, based on the on-going performance of service providers as this is observed and assessed by clients. Example of physical entities include users requesting a service (i.e. clients), or physical service providers offering a type of service (e.g. retail service). Examples of digital entities include avatars acting on behalf or under the direction of physical users, and any other computer programs acting as agents requesting services or providing services over a computer network.

The methods and systems described herein are useful for establishing a network of interacting entities, maintaining the network of interacting entities and reducing impact of malicious agents/actors in the network of interacting entities.

As an example of further variation, implementation of the method and system may accommodate any technique, for example manual or automated, to be used by a requester/client to assign OT and OD values after its interaction with a service received from a service provider. These may include, without limitation, fuzzy logic, statistical analysis, probabilistic reasoning etc. In one example, a client sets its expectations from the service in the form of models, such as goal models [29]. The user-provided goal models may specify the client's requirements, as far as this particular type of service type is concerned. Service provider nodes may be proxies of actual services, monitoring components may automatically evaluate the QoS offered by a service provider and as this is assessed by a client's perspective. Based on the type of service provided, a proxy can attain and process information regarding a multitude of service quality characteristics such as the security protocols used, the speed of the transaction, the provenance of the data used by the service, or even the location of the server hosting the service. The data can be used as input to a goal model denoting the client's expectations from the service. The level of satisfaction of this goal model will yield the OT(p, s) and OD(p, s) for client p using service s. The evaluation of the goal models may take various forms. For example, following an approach described in [30], goal models are transformed into fuzzy rules, which are, in turn, evaluated using a fuzzy reasoner. The result of the evaluation would indicate how well the service performed based on the client's requirements. One example of such a goal model denoting a client's expectations from a service provider can be seen in FIG. 16.

As another example of variation, ranking algorithms can be modified from a variety of mathematical streams. Algorithms that aim to combine positive and negative opinions or evidences to support an hypothesis have been explored in the context on reasoning under uncertainty, probabilistic reasoning, and evidential reasoning [32]. In this respect, some related theories include Bayesian reasoning, Certainty Factors (CFs), Markov Logic rules [33], Dempster-Shafer [28] reasoning, as well as other custom-made approaches such as weighted sums.

Bayesian reasoning with or without calculation of credible intervals, even though formal, requires a significant amount of calculation of various combinations of conditional probabilities which often are difficult to be estimated when many positive and many negative opinions are to be considered when there is a large number of recommenders, each offering its own opinion [32]. Certainty Factors [32],[34] were proposed as a way to assign weights to facts and rules, so deduction using rule-based systems can benefit from incomplete or uncertain knowledge fed to these rules, eliminating thus the limitation of Boolean Logic which recognizes only True and False values. In rule-based systems, rules provide the logic by which positive and negative evidences are combined. Certainty Factors provide a simple but an ad-hoc way of dealing with combination of evidences (i.e. positive and negative opinions), and are mostly applicable in rule-based systems, and in some cases provide non-intuitive results. Markov Logic reasoning has been proposed as a theory to merge Machine Learning and Rule-based systems. This theory aims to train a set of rules so that they best fit on a sample set, used as training set. The process yields weights for each rule, signifying the importance of each rule. Markov Logic rules are most applicable in systems where change does not happen often, otherwise the whole system has to be re-trained. Dempster Shafer reasoning provides an intuitive yet formal way to combine evidences (i.e. opinions from the various recommenders) based on belief measures of each evidence (opinion collected). In this respect, the opinions of the various recommenders for each candidate service are considered as evidences that need to be combined. The Dempster Shafer reasoning does not require the use of rules, does not require training data sets, and can be easily adapted to the problem at hand. Of course, a person of skill in the art can devise a plurality of other algorithms to combine the opinions of the recommenders. For example, a simple but less accurate or intuitive way to combine evidences (i.e. positive and negative opinions) could be to compute a sum of all positive and negative opinions, each opinion been weighted by how reliable the recommender providing the opinion is (i.e. how high its AR value is).

As another example of variation, the system and method can incorporate a component to remove obsolete offsets. In the update process of trust and distrust values (T(p,s) and D(p,s)) and reputation values (R(p,r)), every time an adjustment is made, a notification can be generated. Based on the specific context and the observed frequency of interactions, a time window can be defined and each received notification can be timestamped and filed. A process can be executed to discover obsolete values, taking into consideration the corresponding time window and each value's timestamp. Once an applied offset is deemed to be outdated, the appropriate procedure is run to remove the effect of said value. Examples of procedures are presented in Algorithm 4 and correspond to either trust/distrust or reputation offsets.

Algorithm 4: Remove obsolete offsets.

| | |
|---|---|
| 1: | - Let p be the node that asked for recommendation |
| 2: | - Let r be the node that recommended a service |
| 3: | - Let s be a utilized service provider |
| 4: | |
| 5: | procedure deleteTDOffset(Toffset(p, s), Doffset(p, s), T(p, s), D(p, s), count(p, s)) |
| 6: | if count(p, s) <= 1 then |
| 7: | /* This is the only set of trust/distrust values to |
| 8: | be removed */ |
| 9: | T(p, s) = null |
| 10: | D(p, s) = null |
| 11: | else |
| 12: | /* The offset needs to be removed */ |
| 13: | T(p, s) = T(p, s) − Toffset(p, s) |
| 14: | D(p, s) = D(p, s) − Doffset(p, s) |
| 15: | count(p, s) = count − 1 |
| 16: | end if |
| 17: | end procedure |
| 18: | |
| 19: | procedure deleteROffset(Roffset, R(p, r), count(p, r)) |
| 20: | if count(p, r) <= 1 then |
| 21: | /* This is the last recommendation to |
| 22: | be removed */ |
| 23: | R(p, r) = null |
| 24: | else |
| 25: | /* The offset needs to be removed */ |
| 26: | R(p, r) = R(p, r) − Ro f f set(p, r) |
| 27: | count(p, r) = count − 1 |
| 28: | end if |
| 29: | end procedure |

Note that the number of updates that have contributed to a value is, also, maintained (i.e count(p, r)). The interaction counter is checked (lines 6, 20) and when the last of the adjustments has to be reverted, the values (line 9-10), or value (line 23), are invalidated and removed altogether. This example opts to totally get rid of the value to signify the lack of connection in the social graph and differentiate between lack of value and a series of very bad recommendations or interactions that would lead to a zero value. If, however, the offset(s) to be removed is not the last one, the Toffset(p,s) and Doffset(p,s) values, or Roffset(p, r) value, are subtracted from the T(p,s) and D(p,s) cumulative values (lines 13-14), or R(p,r) respectively (line 26). The interaction counter is, also, decreased by 1 (lines 15, 27), indicating that there is one less interaction contributing to the cumulative values.

As another example of variation, many different approaches for compiling and selecting recommenders can be accommodated. For example, when selecting recommenders that satisfy selection criteria for global reputation (also referred to as overall reputation), the above described approach of updating an AR value after each requester-provider interaction may be substituted with global/overall reputation calculations and selection at the time a service query is submitted by the requester. As a further example, recommenders with global/overall reputation values may be assessed with an algorithm that replaces the need for an AR algorithm, for example an algorithm that filters all recommenders by those that have a frequency of selected recommendations over a time period that exceeds a predetermined threshold and then ranking the subset of recommenders yielded by the filter according to R values (or accumulated R values such as average R value) over the noted time period or alternatively any predetermined number of R values within the noted time period or any part of the noted time period. Similarly, approaches for selecting local recommenders that a have a neighboring or proximal linkage to the requester/client may be varied. Most variant approaches will typically result in selection of a combination of recommenders that includes a consideration of global/overall recommender reputation values (recommenders that need not have a neighboring or proximal linkage to the requester) and local recommender reputation values (for which the client has a personal/neighboring or proximal linkage) as compared to consideration of either global recommender reputations alone or local recommender reputations alone.

As another example of variation, calculation of global/overall reputation values may be varied or modified according to conventional techniques. For example, the calculation of the AR(r) value of each node r which depends on R(w,r) reputation values assigned to the node in question by other nodes w. Simplification of consideration of all available values, avoids a complexity burden as the number of values could grow exponentially as more and more users participate in the network. Furthermore, not all opinions need to bear the same significance, especially if they are older or not updated at the same frequency as other ones. Old or not frequently used values may indicate a recommender who is either not actively participating in the network or may have stale or obsolete opinions about certain service providers who may have changed their behaviour or quality of service in the time elapsed since their last interaction with the recommender in question. For that reason, a way to come up with a subset of available values may be advantageous. One could choose to sort the R(w,r) values by the time they were last updated and disregard the ones that were least recently used (LRU [35]). Another option would be to sort based on number of updates so far and exclude those with the lowest frequency of updates (LFU [36]). Furthermore, a hybrid approach could provide an advantage over either LRU alone or LFU alone, since a hybrid approach captures the significance of recent and thus relevant values, but also allows for some leeway when it comes to values that are usually active but for some reason have not been updated recently. Hybrid approaches may be adapted from cache management techniques, for example Adaptive Replacement Cache (ARC) policy [37] which combines LRU and LFU approaches, while maintaining low computational overhead.

As an illustrative example of adapting ARC to calculation of global/overall reputation values, two ordered lists are maintained for each recommender node r, which are used to identify the relations and corresponding reputation values (R^{r}_{w} and R(w, r) respectively, where w are recommenders of r) that are to be used for the calculation of the AR(r) value of node r. The first list (MRUr) is utilized to maintain the relations pertaining to the most recently updated reputation values put forward by other nodes, whereas the second list (MFUr) includes relations whose corresponding values have been updated most frequently. Also specified is a list of size c that contains the top parts of both lists and accounts for the most important relations whose reputation values are to be considered in the calculation of the corresponding AR(r) value (IMPr). Whenever a new R(w,r) value becomes available, the lists corresponding to the receiver of said value are checked. The available scenarios (A to C) in this example are as follows:
(A) if the relation R^{r}_{w}, corresponding to the new reputation value R(w,r), is in the top of either of the two lists (i.e. part of the TMPr list), it is moved to the top of the MFUr list. In this case, the previous value is, practically, substituted and the update consists of excluding the old and including the new value.
(B) if the relation R^{r}_{w}, corresponding to the new reputation value R(w,r) is part of either the MRUr or the MFUr list, but not part of the top, it is still moved to the top of the MFUr list. However, a relation coming from another recommender is removed to make space for the new relation. The corresponding values are marked for exclusion and inclusion, respectively.
(C) if the relation R^{r}_{w}, corresponding to the new reputation value R(w,r) is not part of any of the lists, it becomes the top one in MRUr and the associated value is deemed to be the one included in the calculation. Relation R^{r}_{w} replaces another relation R^{r}ₖ, whose corresponding reputation value R(k,r) is excluded from the calculation as a result.

For complete removal of a R(w,r) relation, the removed value is flagged to be removed from consideration for the calculation of the corresponding AR(r) value, if the corresponding relation R^{r}_{w} was part of the IMPr list. Then, the next available reputation value R(k,r), corresponding to the relation R^{r}ₖ that was part of the MRUr or MFUr list, based on where the removed relation belonged, but not of the IMPr list, is included.

Note that, the list with the values that are to be considered for the calculation of an AR(r) value (i.e. the IMPr list) is comprised of the relations at the top of the two other lists and its size is fixed, but the amount of elements taken from each of the lists changes.

As another example of variation, implementation of the method and system may benefit many different fields of transactional activities.

For example, a client can seek to buy a mobile phone from various sellers. In this respect, the client issues a request to a central service hosting a framework for the network of interacting entities. The central service identifies recommenders who have bought mobile phones from any of the known to the central system retailers (i.e, the service providers). These recommenders are obtained from a) the best recommenders overall, known to the central service; b) recommenders with which the client has obtained recommendations in the past and has high opinion about them (i.e. the client's friends); and c) recommenders which are friends-of-friends of the client. The central service obtains the recommendations, combines the positive and negative recommendation aspects from each recommender (i.e the evidences), combines the evidences in a score suitable for ranking (e.g. a numerical score), and presents to the client, a list of ranked services to choose from. In a variation of this example, the central service may choose the providers on behalf of the client based on some criteria that the user has set (for example, a combination of ranking and frequency of service utilization so far). The client selects the retailer and buys the cell phone. The client provides its positive and negative experiences from the interaction and product it bought from the retailer, and the reputation of the recommenders is updated accordingly, as well as the reputation of the service in the eyes of the client who have used it. The recommenders do not need to know who the client is. In a variation of this example, the recommenders can also be chosen from the client's social network (e.g. Facebook, Instagram) and with whom the client has close interaction. The system and method addresses the very important issue of fake or malicious reviews, as malicious recommenders or service providers posing as reliable providers will be identified very quickly (see Experimental Exemplification), and isolated.

In another example of variation, a news outlet acting as a central service, makes available to users posts about an event or a person, as these are obtained by a news source (e.g. a reporter, or a news agency). A client can issue a request whether a post is true or fake. The news outlet can collect opinions of others as described in the invention (acting as recommenders) about the post. Some opinions will be positive indicating that the post is valid, while others may indicate that the post is fake. Over a short period of time, the reputation of recommenders who falsely tag posts as true while these are fake, is reduced and their opinion will eventually will not be taken into account, while the trustworthiness of the source producing the post will also be reduced. The network will reach an equilibrium of reliable recommenders and reliable sources providing substantial help towards addressing the problem of fake news or posts produced by physical (e.g. reporters) or virtual entities (e.g. AI platforms). In a variation of this example, granularity can be provided on specific types of posts for which a producer is not trustworthy (e.g. posts about technology, or finance).

In another example of variation, a social platform may offer an online multi-player social game. Users associate with, or control, avatars that exchange or seek goods traded in an on-line forum as part of the game or as part of ad-hoc interactions among the participants. These goods may take the form of products such as Non-Fungible Tokens (NFTs), or services (e.g. an observed behavior which is part of the gaming scenario) provided by avatars. The method an system allows for building an on-line community of avatars, similar to a human community. The game, or trading platform, will allow avatars to act as clients seeking services from other avatars, avatars acting as providers offering goods and services, and recommenders endorsing or not service providers. In this respect, a virtual world can be constructed (i.e. metaverse) where avatars (i.e. digital entities) can interact in a manner resembling human interactions and behavior with respect to reputation based trust of third parties. The method and system can help build very dynamic virtual metaverse worlds, either for gaming or actual trading, where participants are evaluated based on their reputation (i.e. the trust others have on their behavior).

As another example, the system described herein can tolerate variation in its configuration and architecture. The system will make use of a memory or repository where a client can retrieve and store R, AR, T and D values. The system can be configured in two modes. The first mode is referred to as centralized, while the second mode as distributed. In centralized mode a central database or repository stores all pertinent to A, AR, T, and D values for the whole system. In one variation of this centralized architecture there can be different replicated databases or repositories in various geographical locations so that latency between clients and their closest to them database can be minimized. In another variation of the centralized mode, the information is stored in public ledgers using a blockchain architecture. In this respect the clients requesting T, D, R, or AR values can obtain this information from a ledger which has recorded these values and which cannot be contested by any other client as these are now part of the blockchain.

In distributed mode, each client holds locally information about the R, AR, T, and D values it knows, and provides this information to any other client who is requesting it.

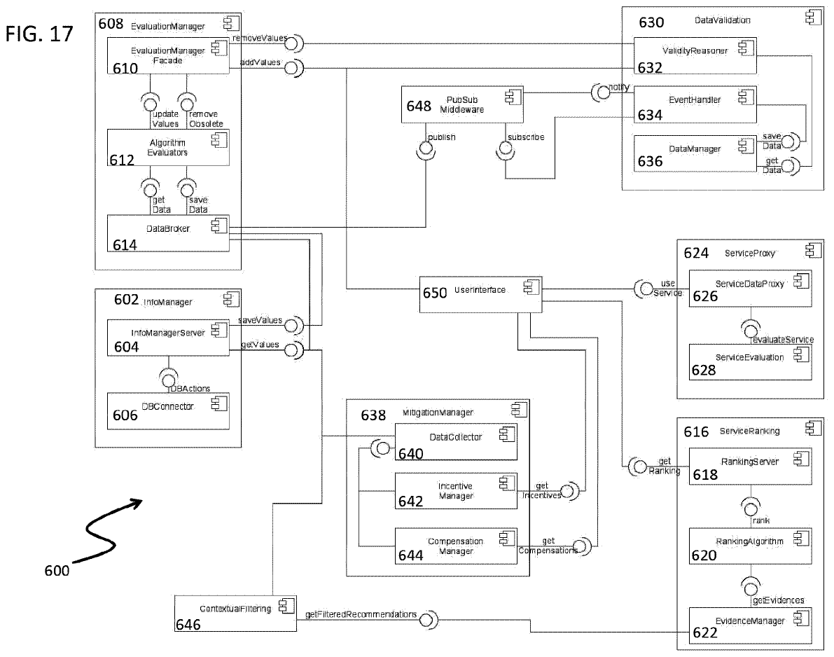

With reference to FIG. 17, an example of a centralized architecture for a system 600 is described for further illustration of computing components.

InfoManager 602: This component is tasked with maintaining the information regarding all relationships between recommenders and service providers. Every relation pertaining to the social graph maintained by the system is stored in this component.
InfoManagerServer 604: This sub-component allows for the services of the InfoManager component to be offered to other components. A standalone server is operated as part of this sub-component, including the corresponding error handling of REST calls. Unmarshalling of the messages is, also, performed by this part of the system for the information to be utilizable by other components.
DBConnector 606: The connectors and error handling for the required databases are included in this sub-component. Several low level checks regarding the incoming and outgoing values are, also, performed here. More specifically, duplicate values are discarded and entries with a count of zero are removed altogether, to signify that the connection in the social graph is no longer present.

EvaluationManager 608: This component provides the functionality of reevaluating the values corresponding to the relationship between different entities. Any update required for T/D, R or AR values is handled by this component.
EvaluationManagerFacade 610: The API of the main component is offered through this sub-component. Again, a server is responsible for handling incoming REST calls and dealing with protocol errors and unmarshalling of data.
AlgorithmEvaluators 612: The actual implementations of the evaluation algorithms are contained here. The calculation of each required value update is assigned to a different thread, in order to improve performance, and the produced values are, then, forwarded to other interested components for saving or further utilization.
DataBroker 614: This sub-component is utilized by the AlgorithmEvaluators sub-component to handle any needs for sending or receiving any information relevant to the evaluation algorithms. Its functionality includes communicating with the InfoManager component to a) obtain the information required when a evaluation of a relationship value is needed or b) save the values updated using the algorithms. This subcomponent is, also, responsible with publishing the calculated offset and R values for them to be used by interested components.

ServiceRanking 616: A ranking of available services is provided by this component to any requesting user, based on the opinions of other users participating in the framework. Recommenders are selected, recommendations are collected and transformed into evidences and the chosen ranking algorithm is executed. Different ranking algorithms can be utilized and the choices regarding the consulted recommenders can be parameterized.
RankingServer 618: This sub-component provides the ranking service to the other components. A server is run to provide said ranking service in a RESTful way and handle any upcoming communication errors.
EvidenceManager 620: This sub-component allows for the selection of recommenders that fulfill certain criteria. Trust and distrust values are collected from selected recommenders and are then transformed into evidence to be considered by the RankingAlgorithm sub-component.
RankingAlgorithm 622: The ranking algorithm is implemented as part of this subcomponent. All available evidence are obtained from the EvidenceManager subcomponent and the algorithm is executed to produce the ranking. The algorithm utilized as an example is a modified version of Dempster-Shafer. To further improve the system's throughput, each request for ranking is handled by a separate thread.

ServiceProxy 624: A proxy for using a service and, subsequently, obtaining data and evaluating said service is implemented here. The service client can only use the selected service through the corresponding proxy.
ServiceDataProxy 626: The actual call to the chosen service is performed through this sub-component. Metrics of interest are automatically collected from the interaction, as well as the user's review. Different implementations regarding data gathering can be included in this sub-component, as well as GUIs to acquire the client's review immediately following the interaction.
ServiceEvaluation 628: Obtained information are provided by the ServiceDataProxy sub-component and the service is evaluated using the selected method or algorithm. In an illustrative implementation, the extended goal models and fuzzy reasoning as defined in [30] may be used. In each case, the appropriate goal model is evaluated to provide the observed trust and distrust values for the utilized service.

DataValidation 630: This component is tasked with two distinct responsibilities: a) It keeps track and notifies the system of previously observed trust and distrust values and the corresponding fluctuations of recommender values that have become obsolete, and b) it maintains a list of recommender values that contribute to the overall reputation of a recommender (AR algorithm). In both cases, the EvaluationManager component is notified to update the corresponding values.
EventHandler 632: This sub-component is responsible with subscribing to the topics that correspond to the values of interest. It, also, provides call-back methods to be called when new data become available. Said methods receive the published data, timestamp them and transform them in a format that is appropriate for saving by the DataManager sub-component.
ValidityReasoner 634: The algorithm used for deciding the recommender values to be considered for the overall reputation of a recommender (AR algorithm) is implemented here. Note that the sub-component is structured in a way that different algorithms can be utilized if required. The logic for discovering obsolete values is, also, implemented here. All of those processes are independent to the main process, so separate threads are utilized to ensure that they run uninterrupted and without delays.
DataManager 636: The data required by the ValidityReasoner are handled by this subcomponent. A distributed database solution is used to allow for replication of this component. Data are inserted by the EventHandler sub-component or retrieved by the ValidityReasoner sub-component.

MitigationManager 638: This component evaluates mitigation strategies that may be offered by specific services. The component, corresponding to the client requesting a service, communicates with this component both during the ranking process and after the service utilization to inquire for available incentives and compensations respectively.
IncentiveManager 640: Incentives may be provided by a service that is new or has performed poorly in the past. Said incentives are calculated using models specified in this sub-component. After the original ranking is provided, a request is made to this sub-component to provide them to the client. A server is included in this component, so that the information can be accessed through a REST API.
CompensationManager 642: Compensations may be given by a service in case of an interaction that didn't perform as expected. The models utilized to calculate them are part of this sub-component. This component is consulted for available compensations after the client has chosen and actually used a specific service.
DataCollector 644: If complimentary data are required for the evaluation of incentive or compensation models, the DataCollector is utilized. Data are collected from the InfoManager component to be provided to any models that might need them. Potential needs may include knowledge of past performance or current reputation.

ContextualFiltering 646: Filtering of available services is performed here, based on contextual information or specific ontologies, before evidence is collected by the ServiceRanking component.

PubSubMiddleware 648: This a middleware framework incorporated in our system to allow decoupling communication between different components. Instances or replicas of the EvaluationManager component publish the calculated offsets and R values and they are received by subscribing DataValidation instances.

UserInterface 650: Each user participates and interacts with the framework through this component. The service client has access to all the functionality offered by the system and is assigned a specific ID and corresponding reputation based on interactions performed using this component. Specific implementation could include a graphical UI or an API to be consumed by other applications.

As another example, the system and method can accommodate variation in computer technology stack or infrastructure including variation in server configurations, communication protocols, memory structures and memory formats. As another example, embodiments disclosed herein, or portions thereof, can be implemented by programming one or more computer systems or devices with computer-executable instructions embodied in a non-transitory computer-readable medium. When executed by a processor, these instructions operate to cause these computer systems and devices to perform one or more functions particular to embodiments disclosed herein. Programming techniques, computer languages, devices, and computer-readable media necessary to accomplish this are known in the art.

In an example, a non-transitory computer readable medium embodying a computer program for reducing impact of malicious components in a network of interacting entities may comprise: computer program code for providing a computer network configured to communicatively connect a requester to a plurality of recommenders and a plurality of providers, at least a portion of the plurality of recommenders being clients of at least a portion of the plurality of providers, a requester-recommender interaction characterized by a reputation value, a requester-provider interaction characterized by a client trust value and client distrust value that are both independent such that a sum of each corresponding client trust value and client distrust value is variable; a recommender-provider interaction characterized by a recommender trust value and recommender distrust value that are both independent such that a sum of each corresponding recommender trust value and recommender distrust value is variable; computer program code for providing an interface connected to the computer network, the interface configured to receive from the requester a query including information relating to a type of service; computer program code for identifying a provider based on the type of service; computer program code for sending to the requester, a recommendation of the provider based on a recommender trust value and a recommender distrust value evaluating performance of the provider, both the recommender trust value and the recommender distrust value being independent such that the sum of the recommender trust value and the recommender distrust value is variable; computer program code for receiving from the requester, an observed trust value and an observed distrust value evaluation of performance of the provider in a requester-provider interaction, both the observed trust value and the observed distrust value being independent such that the sum of the observed trust value and the observed distrust value is variable; computer program code for revising a recommender reputation value by comparing the observed trust value and the observed distrust value to the recommender trust value and the recommender distrust value; computer program code for revising a client trust value and client distrust value for the provider based on the observed trust value and observed distrust value.

The computer readable medium is a data storage device that can store data, which can thereafter, be read by a computer system. Examples of a computer readable medium include read-only memory, random-access memory, CD-ROMs, magnetic tape, optical data storage devices and the like. The computer readable medium may be geographically localized or may be distributed over a network coupled computer system so that the computer readable code is stored and executed in a distributed fashion.

Computer-implementation of the system or method typically comprises a memory, an interface and a processor. The types and arrangements of memory, interface and processor may be varied according to implementations. For example, the interface may include a software interface that communicates with an end-user computing device through an Internet connection. The interface may also include a physical electronic device configured to receive requests or queries from a device sending digital and/or analog information. In other examples, the interface can include a physical electronic device configured to receive signals and/or data relating to the method and system, for example a service query from a requester including data relating to a type of service.

Any suitable processor type may be used depending on a specific implementation, including for example, a microprocessor, a programmable logic controller or a field programmable logic array. Moreover, any conventional computer architecture may be used for computer-implementation of the system or method including for example a memory, a mass storage device, a processor (CPU), a graphical processing unit (GPU), a Read-Only Memory (ROM), and a Random-Access Memory (RAM) generally connected to a system bus of data-processing apparatus. Memory can be implemented as a ROM, RAM, a combination thereof, or simply a general memory unit. Software modules in the form of routines and/or subroutines for carrying out features of the system or method can be stored within memory and then retrieved and processed via processor to perform a particular task or function. Similarly, one or more method steps may be encoded as a program component, stored as executable instructions within memory and then retrieved and processed via a processor. A user input device, such as a keyboard, mouse, or another pointing device, can be connected to PCI (Peripheral Component Interconnect) bus. If desired, the software may provide an environment that represents programs, files, options, and so forth by means of graphically displayed icons, menus, and dialog boxes on a computer monitor screen. For example, any number of dialogue boxes, interactive interstitials and prompts may be displayed, including for example a service query entry form.

Computer-implementation of the system or method may accommodate any type of end-user computing device including computing devices communicating over a networked connection. The computing device may display graphical interface elements for performing the various functions of the system or method, including for example display of a ranked provider list tabulated to show ranking scores. For example, the computing device may be a server, desktop, laptop, notebook, tablet, personal digital assistant (PDA), PDA phone or smartphone, and the like. The computing device may be implemented using any appropriate combination of hardware and/or software configured for wired and/or wireless communication. Communication can occur over a network, for example, where remote control of the system is desired.

If a networked connection is desired the system or method may accommodate any type of network. The network may be a single network or a combination of multiple networks. For example, the network may include the internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet. For example, the network may comprise a computer network that makes use of a TCP/IP protocol (including protocols based on TCP/IP protocol, such as HTTP, HTTPS or FTP).

Embodiments described herein are intended for illustrative purposes without any intended loss of generality. Still further variants, modifications and combinations thereof are contemplated and will be recognized by the person of skill in the art. Accordingly, the foregoing detailed description is not intended to limit scope, applicability, or configuration of claimed subject matter.

1. A computer-implemented method for reducing impact of malicious components in a network of interacting entities, the method comprising:
providing a computer network configured to communicatively connect a requester to a plurality of recommenders and a plurality of providers, at least a portion of the plurality of recommenders being clients of at least a portion of the plurality of providers, a requester-recommender interaction characterized by a reputation value, a requester-provider interaction characterized by a client trust value and client distrust value that are both independent such that a sum of each corresponding client trust value and client distrust value is variable; a recommender-provider interaction characterized by a recommender trust value and recommender distrust value that are both independent such that a sum of each corresponding recommender trust value and recommender distrust value is variable;
providing an interface connected to the computer network, the interface configured to receive from the requester a query including information relating to a type of service;
identifying a provider based on the query;
sending to the requester, a recommendation of the provider based on a recommender trust value and a recommender distrust value evaluating performance of the provider, both the recommender trust value and the recommender distrust value being independent such that the sum of the recommender trust value and the recommender distrust value is variable;
receiving from the requester, an observed trust value and an observed distrust value evaluation of performance of the provider in a requester-provider interaction, both the observed trust value and the observed distrust value being independent such that the sum of the observed trust value and the observed distrust value is variable;
revising a recommender reputation value by comparing the observed trust value and the observed distrust value to the recommender trust value and the recommender distrust value; and
revising a client trust value and client distrust value for the provider based on the observed trust value and observed distrust value.

2. The method of claim 1, wherein:
the client trust value for the provider is a historically accumulated trust value pairwise specific to the requester and the provider calculated based on the observed trust value and a previous trust value recorded prior to the requester-provider interaction; and
the client distrust value for the provider is a historically accumulated distrust value pairwise specific to the requester and the provider calculated based on the observed distrust value and a previous distrust value recorded prior to the requester-provider interaction.

3. The method of claim 2, wherein:
the previous trust value is accumulated from a plurality of previous trust values pairwise specific to the requester and the provider;
the client trust value is revised based on the observed trust value, the previous trust value, and a trust-data aging parameter;
the previous distrust value is accumulated from a plurality of previous distrust values pairwise specific to the requester and the provider; and
the client distrust value is revised based on the observed distrust value, the previous distrust value, and a distrust-data aging parameter.

4. (canceled)

5. The method of claim 3, further comprising:
calculating a trust-data aging offset based on the discrepancy between the observed trust value and the previous trust value weighted by the trust-data aging parameter; and
calculating a distrust-data aging offset based on the discrepancy between the observed trust value and the previous trust value weighted by the distrust-data aging parameter.

6. The method of claim 1, wherein the recommender reputation value is a historically accumulated reputation value pairwise specific to the requester and the recommender calculated based on the observed trust value and the recommender trust value discrepancy, the observed distrust value and the recommender distrust value discrepancy, and a previous reputation value recorded prior to sending the recommendation.

7. The method of claim 6, wherein the previous reputation value is accumulated from a plurality of previous calculated recommender reputation values pairwise specific to the requester and the recommender; and the recommender reputation value is revised based on the observed trust value and the recommender trust value discrepancy, the observed distrust value and the recommender distrust value discrepancy, the previous reputation value and a reputation-data aging parameter.

8. The method of claim 7, further comprising calculating a reputation-data aging offset based on the observed trust value and the recommender trust value discrepancy, the observed distrust value and the recommender distrust value discrepancy, and weighting by the reputation-data aging parameter.

9. The method of claim 1, further comprising revising an overall recommender reputation value for the recommender based on a plurality of recommender reputation values specific to the recommender, each of the plurality of recommender reputation values pairwise specific to the recommender and a unique single client from a plurality of clients; and wherein the overall recommender reputation value is revised over time based on the plurality of recommender reputation values with each of the plurality of recommender reputation values weighed according to an overall reputation value specific to each corresponding unique single client.

10. (canceled)

11. The method of claim 1, wherein the recommendation presents a plurality of providers in a ranked list; and wherein the plurality of providers are ranked by executing a combined positive and negative evidence algorithm and establishing a belief interval or credible interval for each of the plurality of providers.

12. (canceled)

13. (canceled)

14. The method of claim 1, wherein each of the plurality of recommenders is independently selected from the group consisting of:
a first recommender that has an existing first reputation value pairwise specific to the requester and the recommender;
a second recommender lacking a history of direct interaction with the requester, the second recommender having an existing second reputation value pairwise specific to the first recommender and the second recommender; and
a third recommender having an overall reputation value that matches a predetermined selection criteria.

15.-20. (canceled)

21. A system for reducing impact of malicious components in a network of interacting entities, the system comprising:
a computer network configured to communicatively connect a requester to a plurality of recommenders and a plurality of providers, at least a portion of the plurality of recommenders being clients of at least a portion of the plurality of providers;
a memory configured to store: a reputation value characterizing a requester-recommender interaction; a client trust value and client distrust value both characterizing a requester-provider interaction and that are both independent such that a sum of each corresponding client trust value and client distrust value is variable; a recommender trust value and recommender distrust value both characterizing a recommender-provider interaction and that are both independent such that a sum of each corresponding recommender trust value and recommender distrust value is variable; instructions or operation of the system;
an interface connected to the computer network, the interface configured to receive from the requester a query including information relating to a type of service;
one or more processors configured to access instructions stored in memory and perform operations comprising:
identifying a provider based on the query;
sending to the requester, a recommendation of the provider based on a recommender trust value and a recommender distrust value evaluating performance of the provider, both the recommender trust value and the recommender distrust value being independent such that the sum of the recommender trust value and the recommender distrust value is variable;
receiving from the requester, an observed trust value and an observed distrust value evaluation of performance of the provider in a requester-provider interaction, both the observed trust value and the observed distrust value being independent such that the sum of the observed trust value and the observed distrust value is variable;
revising a recommender reputation value by comparing the observed trust value and the observed distrust value to the recommender trust value and the recommender distrust value; and
revising a client trust value and client distrust value for the provider based on the observed trust value and observed distrust value.

22. The system of claim 21, wherein:
the client trust value for the provider is a historically accumulated trust value pairwise specific to the requester and the provider calculated based on the observed trust value and a previous trust value recorded prior to the requester-provider interaction; and
the client distrust value for the provider is a historically accumulated distrust value pairwise specific to the requester and the provider calculated based on the observed distrust value and a previous distrust value recorded prior to the requester-provider interaction.

23. The system of claim 22, wherein:
the previous trust value is accumulated from a plurality of previous trust values pairwise specific to the requester and the provider;
the client trust value is revised based on the observed trust value, the previous trust value, and a trust-data aging parameter;
the previous distrust value is accumulated from a plurality of previous distrust values pairwise specific to the requester and the provider; and
the client distrust value is revised based on the observed distrust value, the previous distrust value, and a distrust-data aging parameter.

24. (canceled)

25. The system of claim 23, further comprising:
calculating a trust-data aging offset based on the discrepancy between the observed trust value and the previous trust value weighted by the trust-data aging parameter; and
calculating a distrust-data aging offset based on the discrepancy between the observed trust value and the previous trust value weighted by the distrust-data aging parameter.

26. The system of claim 21, wherein the recommender reputation value is a historically accumulated reputation value pairwise specific to the requester and the recommender calculated based on the observed trust value and the recommender trust value discrepancy, the observed distrust value and the recommender distrust value discrepancy, and a previous reputation value recorded prior to sending the recommendation.

27. The system of claim 26, wherein the previous reputation value is accumulated from a plurality of previous calculated recommender reputation values pairwise specific to the requester and the recommender; and the recommender reputation value is revised based on the observed trust value and the recommender trust value discrepancy, the observed distrust value and the recommender distrust value discrepancy, the previous reputation value and a reputation-data aging parameter.

28. The system of claim 27, further comprising calculating a reputation-data aging offset based on the observed trust value and the recommender trust value discrepancy, the observed distrust value and the recommender distrust value discrepancy, and weighting by the reputation-data aging parameter.

29. The system of claim 21, further comprising revising an overall recommender reputation value for the recommender based on a plurality of recommender reputation values specific to the recommender, each of the plurality of recommender reputation values pairwise specific to the recommender and a unique single client from a plurality of clients; and wherein the overall recommender reputation value is revised based on summation of the plurality of recommender reputation values with each of the plurality of recommender reputation values weighed according to an overall reputation value specific to each corresponding unique single client.

30. (canceled)

31. The system of claim 1, wherein the recommendation presents a plurality of providers in a ranked list; and wherein the plurality of providers are ranked by executing a combined positive and negative evidence algorithm and establishing a belief interval or credible interval for each of the plurality of providers.

32. (canceled)

33. (canceled)

34. The system of claim 21, wherein each of the plurality of recommenders is independently selected from the group consisting of:
a first recommender that has an existing first reputation value pairwise specific to the requester and the recommender;
a second recommender lacking a history of direct interaction with the requester, the second recommender having an existing second reputation value pairwise specific to the first recommender and the second recommender; and
a third recommender having an overall reputation value that matches a predetermined selection criteria.

35.-42. (canceled)
